(19) United States
(12) Patent Application Publication
(10) Pub. No.: US 2020/0039316 A1
(43) Pub. Date: Feb. 6, 2020

(54) ACTIVE FORCE CANCELLATION AT STRUCTURAL INTERFACES

(71) Applicant: ClearMotion, Inc., Billerica, MA (US)

(72) Inventors: Joseph Thomas Belter, Somerville, MA (US); Clive Tucker, Charlestown, MA (US); Jack A. Ekchian, Belmont, MA (US); Colin Patrick O'Shea, Boston, MA (US); Marco Giovanardi, Melrose, MA (US); David Ta-wei Hsu, Lexington, MA (US)

(73) Assignee: ClearMotion, Inc., Billerica, MA (US)

(21) Appl. No.: 16/485,927

(22) PCT Filed: Apr. 5, 2018
(86) PCT No.: PCT/US18/26271

§ 371 Date: Aug. 14, 2019

Related U.S. Application Data
(60) Provisional application No. 62/482,151, filed on Apr. 5, 2017.

(51) Int. Cl. B60G 17/0195; B60W 10/22; F16F 15/00; B60G 17/02

(52) U.S. Cl. CPC B60G 17/0195; B60W 10/22; B60G 2400/52; B60G 17/02; F16F 15/005

(57) ABSTRACT

In one embodiment, certain aspects of forces at a structural interface applied by one actuator are mitigated by a secondary actuator that applies a secondary force. In some embodiments the secondary actuator applies a static force. In yet another embodiment, an actuator is used to apply a force on a wheel assembly of a vehicle to detect and/or ameliorate the effect of certain tire incongruities.

### FIELD

Disclosed embodiments are related to the use of actuators in controlling force transfer between structures.

### BACKGROUND

Vibrations experienced by the operator or passenger of a vehicle may substantially degrade ride comfort. Such vibrations may be experienced by the operator or passenger in the form of, for example, noise that permeates the vehicle's cabin, as physical road-induced vibrations of components located in the vehicle's cabin, and or road-induced vehicle body motion. These vibrations may originate, for example, from imperfections in road surface. Alternatively, in active suspension systems, vibrations may originate from oscillations in a force actively applied to one or more components of the suspension system. There is, therefore, a need for technical solutions designed to mitigate the transfer of vibrations through the suspension system of a vehicle into the vehicle body.

### SUMMARY

Presented herein are methods, systems, and apparatuses for mitigating and/or regulating the transfer of certain vibrations, forces, or motions from a first physical structure to a second physical structure and/or between an actuator and a structure. In certain embodiments two structures may be joined by one or more devices which may include one or more of a damping element, a spring element and an actuator, where multiple devices interposed between two structures may be in parallel and/or series combinations. In certain embodiments, an actuator and a structure may be joined by one or more damping and/or spring elements, where multiple devices interposed between two the structure and the actuator may be in parallel and/or series combinations.

Particularly, according to one aspect, a method for mitigating and/or regulating an effect of (e.g., a displacement resulting from, a vibration resulting from) a first force applied to a first component (e.g., a top mount, a vehicle body, a piston rod) may include characterizing (e.g., measuring, predicting via a model) a first set of one or more aspects (e.g., a first magnitude, a first direction, a first duration, any combination or permutation thereof) of the first force (e.g., wherein the first force is applied by a first actuator (e.g., a hydraulic actuator (e.g., an electro-hydraulic actuator)(e.g., an actuator of an active suspension system) to the first component)); determining (e.g., by a reaction actuator controller) a second set of one or more aspects (e.g., second magnitude, second direction, second duration, any combination or permutation thereof), wherein the second set of aspects is determined based at least in part on the first set of aspects (e.g., wherein the second set of aspects is determined based on at least one of (e.g., one of, two of, three of) the first magnitude, the first direction, the first duration) (e.g., wherein the second magnitude is determined based on the first magnitude, wherein the second direction is determined based on the second direction, wherein the second duration is determined based on the first duration) (e.g., wherein the second direction is opposite the first direction)); applying, (e.g. by a reaction actuator) (e.g., a reaction actuator interposed between a reaction mass and the first component), a second force to the first component, the second force being characterized by the second set of aspects, thereby at least partially mitigating the effect of the first force on the first component.

In certain embodiments, the first component is one of (a) a vehicle body and (b) a top mount physically attached to the vehicle body, and the first force is applied to the first component by an actuator component (e.g., a rod (e.g., a piston rod, a housing)) of the first actuator.

Additionally or alternatively, the method may include determining (e.g., by the reaction actuator controller) a reaction signal (e.g., an electrical signal (e.g., a voltage, a current)), such that transmission of the reaction signal to the reaction actuator causes the reaction actuator to generate the second force; and transmitting (e.g., from the reaction actuator controller) the reaction signal to the reaction actuator, thereby causing the reaction actuator to generate the second force.

In certain embodiments, the suspension system includes a cylinder comprising a compression chamber and an extension or a rebound chamber; a piston, wherein the piston is: physically attached to a piston rod, exposed to fluid in the compression chamber on a first side of the piston, and exposed to fluid in the rebound chamber on a second side of the piston opposite the first side of the piston); and a hydraulic pump (e.g., a motor-pump, a bidirectional pump, a gerotor) operatively coupled to a motor (e.g., a motor-generator) (e.g., an electric motor (e.g., a direct current electric motor (e.g., a BLDC))) comprising a rotor and a stator, wherein the hydraulic pump is in fluid communication with the rebound chamber and the compression chamber.

In certain embodiments, characterizing the aspect of the first force may include: accessing a ripple map; receiving, from one or more sensors (e.g., a hall-effect sensor), a position parameter corresponding to an angular position of (i) a rotor of a motor of the suspension system (e.g., the motor operatively coupled to the hydraulic pump) and/or (ii) a rotating element of a pump of the suspension system; and determining (e.g., predicting) one or more values for the aspect of the first force (e.g., a magnitude of the force, a direction of the force, a deviation force relative to a mean, nominal, or commanded force) based at least in part on the ripple map and the position parameter.

Additionally or alternatively, characterizing the aspect of the first force may include: receiving, from one or more sensors, a set of one or more inputs corresponding to: a position of the rotor (e.g., an angular position of the rotor (e.g., an angular position of the rotor in relation to a reference point on the stator)), a load (e.g., a torque) on the motor, a torque applied to the motor, an angular speed of the motor, a state of the motor (e.g., on, off), an amount (e.g., a magnitude, a direction) of force applied to the piston, the pressure difference between the rebound chamber and the compression chamber, a pressure of the rebound chamber, a pressure of the compression chamber, an acceleration of the piston and/or piston rod, a flow rate through the pump, a stress in and/or a strain of the piston rod, a stress and/or strain at one or more points in the top mount; and determining (e.g., predicting) one or more values for the aspect of the first force based at least in part on the set of one or more inputs.

In certain embodiments, the vehicle body is part of a vehicle having a mass between 1,300 to 2,500 kg (e.g., 1,300-1,400 kg., 1,400-1,500 kg., 1,500-1,600 kg., 1,600-1,700 kg., 1,700-1,800 kg., 1,800-1,900 kg., 1,900-2,000 kg., 2,000-2,100 kg., 2,100-2,200 kg., 2,200-2,300 kg., 2,300-2,400 kg., or 2,400 to 2,500 kg.), and the reaction mass has a mass of less than 1 kg (e.g., 0.1-0.9 kg, 0.1-0.2 kg., 0.2-0.3 kg., 0.3-0.4 kg., 0.4 to 0.5 kg., 0.5-0.6 kg., 0.6-0.7 kg., 0.7-0.8 kg., 0.8-0.9 kg., 0.9-1.0 kg.). In some embodiments, a reaction mass may include the rod assembly or damper body of a typical hydraulic damper depending on whether the piston rod or the damper body is attached to the sprung mass of the vehicle.

In another aspect, a vibration-mitigating top mount assembly may include: a reaction actuator (e.g., a linear actuator) (e.g., a piezoelectric actuator, a solenoid actuator, a capacitive actuator, a hydraulic actuator); a reaction mass physically attached to a first side (e.g., a top face) of the reaction actuator; and a reaction actuator controller (for example, open loop, a feed forward, a proportional (P), an integral (I), a proportional-integral (PI), proportional-derivative (PD), or a proportional-integral-derivative (PID) controller) in communication (e.g., in electrical communication) with the reaction actuator, wherein the reaction actuator controller applies a signal (e.g., an electrical signal (e.g., a voltage, a current)) to (e.g., across) the actuator.

In certain embodiments, the vibration-mitigating top mount assembly further includes: a top mount bracket physically attached to a second side (e.g., a bottom face) of the reaction actuator (e.g., such that the reaction actuator is interposed between the top mount bracket and the reaction mass); and a strike plate at least partially disposed within the top-mount bracket, wherein the strike plate is attached to a rod (e.g. a piston rod, a rod fixedly attached to a housing) of a suspension component (e.g., a damper, an actuator) (e.g., wherein the strike plate comprises one or more openings through which the rod may be inserted and secured) .

Alternatively or additionally, the vibration-mitigating top mount assembly may include a mounting member physically attached to a second side (e.g., a bottom face) of the reaction actuator opposite the first side of the reaction actuator, wherein the mounting member is physically attachable to a rod (e.g., a piston rod, a rod fixedly attached to a housing) (e.g., wherein the mounting member comprises one or more openings through which the rod may be inserted and secured (e.g., using a fastener (e.g., a nut))) of a suspension component (e.g., a damper, an actuator).

In certain embodiments, the mounting member is fixedly attached to the rod of the suspension component (e.g., a threaded portion of the rod is inserted into an opening of the mounting member and secured (e.g., using a fastener (e.g., a nut))).

In certain embodiments, the strike plate (e.g., a strike plate comprising one or more openings therethrough) is fixedly attached to the rod of the suspension component (e.g., wherein a top end of the rod is inserted into at least one of the one or more openings and secured (e.g., using a fastener (e.g., a nut))).

In certain embodiments, the suspension component may include: the piston rod; a piston physically connected to the piston rod (e.g., physically connected to a bottom end of the piston rod) and immersed into a cylinder; and the cylinder comprising a compression chamber and an extension or a rebound chamber (e.g., where the piston is exposed to fluid in the compression chamber on a first side of the piston, and exposed to fluid in the rebound chamber on a second side of the piston opposite the first side of the piston).

Alternatively or additionally, the reaction actuator controller may be configured to periodically modulate a value of at least one characteristic of the applied signal (e.g., a magnitude of the applied voltage and/or a direction of the applied voltage, a magnitude of the applied current) based on a first set of inputs (e.g., time-dependent inputs, calculated inputs, measurements of the state of a vehicle or one or more vehicle components), thereby causing periodic variations (e.g., contraction, expansion) in a dimension of the reaction actuator (e.g. it's length along its longitudinal axis).

Alternatively or additionally, the suspension component and/or top mount assembly may include one or more sensors that produce one or more electrical signals corresponding to at least one of: a magnitude of force applied to the piston, a direction of force applied to the piston, an acceleration of the piston, a pressure differential between the rebound chamber and compression chamber, an absolute pressure of the rebound chamber, an absolute pressure of the compression chamber, a net flow rate of fluid between the rebound chamber to the compression chamber; and the reaction actuator controller may be in communication with (e.g., is in electrical communication with) at least one of the one or more sensors.

In certain embodiments, the first set of inputs includes at least one of: the magnitude of force applied to the piston, the direction of force applied to the piston, the acceleration of the piston, the pressure differential between the rebound chamber and the compression chamber, the absolute pressure of the rebound chamber, the absolute pressure of the compression chamber, the net flow rate, an acceleration of the piston and/or piston rod, a stress in or a strain of the piston rod, and a stress or a strain at one or more points in the top mount assembly.

Alternatively or additionally, the suspension component may comprise a hydraulic pump (e.g., a motor-pump, a bidirectional pump, a gerotor) operatively coupled to a motor (e.g., a motor-generator) (e.g., an electric motor (e.g., a direct current electric motor (e.g., a BLDC))) comprising a rotor and a stator, wherein the hydraulic pump is in fluid communication with the rebound chamber and the compression chamber, and wherein applying a torque to the motor (e.g., by supplying electrical power to the motor (e.g., voltage and/or current to the motor) thereby causing the rotor to rotate) generates a pressure difference between the rebound chamber and the compression chamber (e.g., by driving fluid from the rebound chamber to the compression chamber, or from the compression chamber to the rebound chamber), thereby generating a force on the piston which may include high frequency pressure oscillations known as hydraulic flow ripple; and a motor controller (e.g. an open loop, a feed forward, a P, an I, a PI, a PD, or a PID controller) (e.g., comprising a microprocessor) in communication with (e.g., in electrical communication with) the motor and configured to (e.g., programmed to) control operation (e.g., state (e.g., on/off), torque, angular speed) of the electric motor (e.g., based on a second set of inputs).

Alternatively or additionally, the suspension component and/or top mount assembly may include: one or more sensors (e.g., a hall-effect sensor, an accelerometer) in communication with (e.g., in electrical communication with) the reaction actuator controller, wherein the one or more sensors produce one or more electrical signals corresponding to at least one of: a position of the rotor (e.g., an angular position of the rotor (e.g., an angular position of the rotor in relation to a reference point on the stator)), a load (e.g., a torque) on the motor, a torque applied to the motor, an angular speed of the motor, a state of the motor (e.g., on, off), an amount (e.g., a magnitude, a direction) of force applied to the piston, the pressure difference between the rebound chamber and the compression chamber, a pressure of the rebound chamber, a pressure of the compression chamber, an acceleration of the piston and/or piston rod, an acceleration of the suspension component body, a flow rate through the pump, a stress in and/or a strain of the piston rod, a stress and/or strain at one or more points in the top mount assembly.

In certain embodiments, the first set of inputs comprises one or more signals corresponding to at least one of: the position of the rotor, the load on the motor, the torque applied to the motor, the angular speed of the motor, the state of the motor, the amount of force applied to the piston, the pressure difference between the rebound chamber and the compression chamber, the pressure of the rebound chamber, the pressure of the compression chamber, the acceleration of the piston and/or piston rod, the flow rate through the pump, the stress in and/or the strain of the piston rod, the stress and/or strain at the one or more points in the top mount assembly.

Alternatively or additionally, a vibration-mitigating top mount assembly may comprise memory (e.g., non-volatile computer readable memory) storing one or more ripple maps (e.g., a look up table defining pressure differential between the compression chamber and rebound chamber as a function of reference angular position of the rotor, motor torque, and/or motor speed, a look up table defining applied force as a function of reference angular position of the rotor), where the first set of inputs comprises at least one of the one or more ripple maps and the position parameter (e.g., the instantaneous angular position) of the rotor.

In certain embodiments, the ripple maps may be stored locally and/or remotely.

In certain embodiments, the memory stores a plurality of ripple maps, each ripple map corresponding to a reference operating condition of the pump (e.g., a reference direction of rotation, a reference speed of rotation, a reference applied torque, a reference pressure differential across the pump); and the actuator controller is configured to identify an appropriate ripple map from the plurality of ripple maps based on an instantaneous or commanded operating condition (e.g., an instantaneous or commanded direction of rotation, an instantaneous or commanded speed of rotation, an instantaneous or commanded applied torque, an instantaneous or commanded pressure differential); and the first set of inputs comprises the identified appropriate ripple map.

In another aspect, a suspension system for a structure (e.g., a vehicle) comprising a wheel assembly and a body (e.g., a vehicle body) may include: a spring/actuator perch interposed between the wheel assembly and the body, wherein the spring/actuator perch comprises a first surface (e.g., a top surface) and a second surface (e.g., a bottom surface); a spring (e.g., an air spring, a coil spring), wherein a first end of the spring is in physical contact with the body (e.g., via a top mount, directly) and a second end of the spring is in physical contact with the first surface of the spring perch; a perch actuator (e.g., a hydraulic actuator), wherein a first end of the perch actuator is physically attached to the second surface of the spring/actuator perch, and a second end of the perch actuator is physically attached to the wheel assembly; and a second actuator (e.g., a hydraulic actuator, an electro-hydraulic actuator), wherein a first end of the second actuator is physically attached to the first surface of the spring perch and a second end of the second actuator is physically attached to the vehicle body (e.g., via a top mount, directly).

In certain embodiments, the perch actuator includes a housing (e.g., a cylindrical housing), a perch piston slidably inserted into the cylindrical housing, and a first chamber (e.g., a first chamber bound at least in part by an interior surface of the cylindrical housing and a first surface of the perch piston).

Alternatively or additionally, the second actuator may include a cylindrical housing, a piston slidably received in the housing, a compression chamber and an extension chamber (e.g., where the body piston is exposed to fluid in the compression chamber on a first side of the body piston, and exposed to fluid in the extension chamber on a second side of the body piston opposite the first side of the body piston) (e.g., wherein the body piston is interposed between the compression chamber and the extension chamber). In certain embodiments, the first chamber is in fluid communication with an external chamber. In certain embodiments, the external chamber is part of a pressure intensifier. In certain embodiments, the pressure intensifier comprises the external chamber, an air chamber, and an air piston rigidly attached to an external piston, wherein: a first side of the external piston is exposed to fluid (e.g., hydraulic fluid) in the external chamber; a first side of the air piston is exposed to fluid (e.g., air, gas) in the air chamber, wherein a cross sectional area of the external piston is less than a cross sectional area of the air piston. In certain embodiments, the air chamber is in fluid communication with an air pump or air compressor. In certain embodiments, a first valve (e.g., an on/off valve, a variable flow valve (e.g. a passive valve, an electrically controlled valve, a pilot-controlled valve) may be located in an air fluid path between the air compressor and the air chamber. Alternatively or additionally, a second valve (e.g., an on/off valve, a variable flow valve) may be located in a hydraulic fluid path between the external chamber and the first chamber.

In certain embodiments, the spring is an air spring (e.g., an air spring in fluid communication with the air compressor). In certain embodiments, the second actuator is configured to adjust (e.g., raise, lower) a relative position (e.g. vertical position) of the vehicle body relative to the spring/actuator perch. In certain embodiments, the perch actuator is configured to adjust (e.g., raise, lower) a position of the spring/actuator perch relative to the wheel assembly.

In yet another aspect, a diagnostic method or system for evaluating a condition (e.g., inflation level, integrity) of a first tire of a vehicle that is travelling on or stopped on a road or other surface, comprising an active suspension system (e.g., comprising an actuator) capable of actively transmitting a force to the first tire in a direction, for example, that has at least a component that is perpendicular to the surface and/or the tire contact patch (e.g., the area of contact between the tire and the surface) of the first tire. The method or system may include: (i) exerting, by a component of the active suspension system (e.g., an actuator), a vertical force on the first tire; (ii) modifying a characteristic (e.g., a magnitude, a direction, frequency) of the vertical force, thereby effecting a reaction (e.g., a change in vertical position, a vibration) in the first tire; (iii) detecting, by a set of one or more sensors, a set of one or more reaction values, the set of reaction values comprising at least one of: (a) one or more vertical velocity values of one or more wheel components (e.g., one or more points on the first tire, one or more points on a wheel assembly linking the first tire to a vehicle body), (b) one or more vertical acceleration values of one or more wheel components (e.g., one or more points on the first tire, one or more points on the wheel assembly), (c) one or more vertical position values of one or more wheel components (e.g., the magnitude of a displacement of one or more points on the first tire, one or more points on the wheel assembly); and (iv) determining, by a microprocessor in communication with the set of sensors, based at least in part on the set of reaction values, a first tire parameter (e.g., a resonance frequency of the first tire, a spring constant of the first tire). If the context permits, the vertical direction may be defined as a direction that is perpendicular to the road surface and/or the contact patch of the first tire.

In certain embodiments, the diagnostic method includes (v) determining, by the microprocessor, based at least in part on the first tire parameter, an inflation value for the first tire (e.g., wherein the inflation value corresponds to the pneumatic pressure of the tire). In certain embodiments, the first tire parameter is one of: a spring constant of the first tire and a resonance frequency of the first tire, and step (v) comprises: accessing a set of rules (e.g., a look up table, a function) that defines at least one of: (A) tire inflation values as a function of resonance frequency and (B) tire inflation values as a function of spring constant; and determining the inflation value for the first tire by evaluating the determined first tire parameter against the set of rules.

Additionally or alternatively, the diagnostic method may include: (vi) upon determination by the microprocessor that the determined inflation value is one of: greater than a high threshold value or less than a low threshold value, activating (e.g., illuminating) an inflation warning notification (e.g., a light, a sound, an electronic flag).

In certain embodiments, the vehicle comprises a plurality of tires (e.g., wherein the plurality of tires comprises one or more of: the first tire, a second tire, a third tire, and a fourth tire).

Additionally or alternatively, the diagnostic method may include: determining (e.g., by the microprocessor) a plurality of tire parameters (e.g., comprising the first tire parameter and a second tire parameter), (e.g., wherein the first tire parameter is determined with the first tire at a first angular position and the second tire parameter is determined with the first tire at a second angular position) (e.g., wherein each tire parameter of the plurality is determined at a different point in time) (e.g., wherein the first tire parameter is associated with the first tire and the second tire parameter is associated with the second tire); and determining a comparison value by comparing (e.g., by the microprocessor) (e.g., taking a difference, taking a ratio of) a first tire parameter and a reference value (e.g., wherein the first tire parameter is determined with the first tire at a first angular position and the reference value corresponds to a separate tire parameter determined with the first tire at a second angular position) (e.g., wherein the reference value corresponds to an average (e.g. a mean) of at least a subset of the plurality of tire parameters)). In certain embodiments, the diagnostic method includes: upon determination by the microprocessor that the comparison value exceeds a threshold value, activating (e.g., illuminating) an integrity warning notification (e.g., a light, a sound, electronic flag).

Additionally or alternatively, the diagnostic method may include: modifying a mode (e.g., a suspension characteristic (e.g., a wheel control algorithm, a damping ratio)) of the vehicle based at least in part on the determined first tire parameter.

Additionally or alternatively, the method may include: prior to step (i), determining a speed of the vehicle, wherein step (i) is carried out upon determination that the vehicle is stopped or travelling at a slow speed (e.g., less than 10 mph, less than 5 mph, less than 1 mph).

In yet another aspect, a diagnostics system for monitoring a condition (e.g., inflation level, integrity) of a tire of a vehicle comprising an active suspension system capable of actively exerting a vertical force to the tire may include: a set of one or more sensors (e.g., accelerometers, position sensors, velocity sensors), wherein the set of sensors detects a set of one or more reaction values, the set of reaction values comprising at least one of: (a) one or more vertical velocity values of one or more wheel components (e.g., one or more points on the tire, one or more points on the wheel assembly), (b) one or more vertical acceleration values of one or more wheel components (e.g., one or more points on the tire, one or more points on the wheel assembly), (c) one or more vertical position values of one or more wheel components (e.g., one or more points on the tire, one or more points on the wheel assembly); at least one microprocessor in communication with the set of one or more sensors; and a set of instructions wherein the set of instructions, when executed by the microprocessor, cause the microprocessor to determine a spring constant of the tire based, at least in part, on the set of reaction values.

In certain embodiments, the microprocessor is configured to determine an inflation value of the tire based, at least in part, on the determined spring constant. Alternatively or additionally, the diagnostics system may include an inflation warning notification (e.g., a light, a sound, an electronic flag) and, upon determination by the microprocessor that the inflation value is one of: above a high threshold and below a low threshold, the inflation warning notification may be activated (e.g., illuminated). This information may also be shared with other vehicles and/or a remote data base.

In certain embodiments, the set of sensors includes an angular position sensor integrated into the tire, and the microprocessor is configured to determine a plurality of spring constants, each spring constant corresponding to a different angular position of the tire. Alternatively or additionally, the diagnostics system may include an integrity warning notification (e.g., a light, a sound, electronic flag), wherein the integrity warning notification is activated (e.g., illuminated) upon determination by the microprocessor that a comparison value (e.g., a difference, a ratio) between a first spring constant and a second spring constant exceeds a threshold value (e.g., wherein the first spring constant is determined with the tire at a first angular position and the second spring constant is determined with the tire at a second angular position of the tire) (e.g., wherein the first spring constant is determined at a first point in time, and the second spring constant is determined at a second point in time later than the first point in time).

In yet another aspect, a suspension component (e.g., a damper, an actuator (e.g., a hydraulic actuator)) may include: a cylindrical housing (e.g., comprising a port (e.g., an inlet port, outlet port)) having a longitudinal axis; a piston slidably inserted into the housing (e.g., wherein the housing is rotatable about the longitudinal axis (e.g., rotatable relative to the piston)) (e.g., wherein the cylindrical housing is rotatable by at least a given angular range (e.g., rotatable at least 5°, 10°, 15°, 25°, 35°, 45°, 55°, 65°, 75°, 85°, 95°, 105°, 115°, 125°, 135°, 145°, 155°, 165°, 180°) about the longitudinal axis), wherein changing a vertical position of the piston results in a change in an angular position of the cylindrical housing (e.g., relative to the piston) (e.g., a change in an angle of azimuth of the port with respect to a fixed point on the longitudinal axis) (e.g., wherein the cylindrical housing is located at a first angular position (e.g., wherein the port is located at a first angle of azimuth with respect to a fixed point on the longitudinal axis) when the piston is located at a first vertical position, and wherein the cylindrical housing is located at a second angular position (e.g., wherein the port is located at a second angle of azimuth with respect to the fixed point) when the piston is located at a second vertical position).

In certain embodiments, the suspension component may include a piston rod physically attached to the surface of the piston, wherein the rotational axis coincides with a cylindrical axis of the piston rod. Alternatively or additionally, the suspension component may include a first gear at least partially encircling a portion of the cylindrical housing and a second gear operatively coupled to the first gear (e.g., wherein rotation of the second gear causes rotation of the first gear). In certain embodiments, the second gear is physically connected via a mechanical linkage or intermediate body to at least one of: the piston rod, the wheel assembly and the vehicle body (e.g., wherein changing a vertical position of the piston rod results in rotation of the second gear) (e.g., wherein changing a position of the wheel assembly relative to the body results in rotation of the second gear) (e.g., wherein changing a position of the wheel assembly relative to the body results in a change in a position of the mechanical linkage or intermediate body).

In yet another aspect, a method for operating a suspension component comprising a cylindrical housing and a piston slidably inserted into the cylindrical housing may include: changing a vertical position of the piston by a vertical magnitude in a vertical direction (e.g., up, down); rotating the housing (e.g., with respect to the piston) (e.g., about a longitudinal axis of the housing) (e.g., changing an angle of azimuth of a reference point on the housing with respect to a fixed point) by a rotational magnitude in a rotational direction (e.g., counter clockwise, clockwise), wherein at least one of (e.g., one of, both of) the rotational magnitude and rotational direction depend on at least one of (e.g., one of, both of) the vertical magnitude and vertical position of a wheel assembly relative to a body (e.g., the rotational magnitude depends on the vertical magnitude and/or the rotational direction depends on the vertical direction).

It should be appreciated that the foregoing concepts, and additional concepts discussed below, may be arranged in any suitable combination, as the present disclosure is not limited in this respect. It is envisioned that any embodiments may be combined. Further, other advantages and novel features of the present disclosure will become apparent from the following detailed description of various non-limiting embodiments when considered in conjunction with the accompanying figures. Further, it should be understood that the various features illustrated or described in connection with the different exemplary embodiments described herein may be combined with features of other embodiments or aspects. Such combinations are intended to be included within the scope of the present disclosure.

### BRIEF DESCRIPTION OF DRAWINGS

The accompanying drawings are not intended to be drawn to scale. In the drawings, identical or nearly identical components illustrated in various figures may be represented by a like numeral. For purposes of clarity, not every component may be labeled in every drawing.

FIG. 1 illustrates an example of an electro-hydraulic actuator that may be used in an active vehicle suspension system.

FIG. 2 illustrates an embodiment of an active vibration-mitigating top mount assembly.

FIG. 3 illustrates another embodiment of an active vibration-mitigating top mount assembly.

FIG. 4 illustrates embodiments of a pressure differential map and a pressure ripple map.

FIG. 5 illustrates an embodiment of a feed forward model.

FIG. 6 illustrates an embodiment of an active vibration-mitigating top mount assembly in which the hydraulic actuator is in an inverted orientation.

FIG. 7 illustrates a schematic of an embodiment of a test system for generating a ripple map.

FIG. 8 illustrates an embodiment of an electro-hydraulic actuator that may be integrated into an active suspension system.

FIG. 9 illustrates another embodiment of an electro-hydraulic actuator that may be integrated into an active suspension system.

FIG. 10 illustrates an embodiment of suspension system including an active spring/actuator perch.

FIG. 11 illustrates a tire diagnostics system including an active suspension system.

FIGS. 12A-12C illustrate an embodiment of an actuator that may be integrated into an active suspension system.

FIG. 13 illustrates a system with a first actuator interposed between two structures and a second actuator for mitigating the effect of parasitic force components produced by the first actuator.

FIG. 14 illustrates an embodiment of a suspension system top mount assembly attached to the piston rod of an actuator.

### DETAILED DESCRIPTION

Having discussed the current disclosure generally above, certain exemplary embodiments are now described in more detail to provide an overall understanding of the principles of the structure, function, manufacture, and use of the system, apparatuses, and methods described herein. However, it should be understood by one of ordinary skill in the art that the systems, methods, and example described herein and illustrated in the accompanying drawing are non-limiting exemplary embodiments. In the case of any conflict between an incorporated reference and the present specification, the present specification shall control.

While methods, systems, and apparatuses described herein are largely described in embodiments applicable to a road vehicle including an active suspension system, the disclosure is not so limited. Rather, as would be understood by one of ordinary skill in the art, it is envisioned that the methods, systems, and apparatuses described herein may find use in a variety of applications wherein it is beneficial to mitigate the transfer of vibrations from one physical structure to a second physically connected structure.

Suspension systems in vehicles serve, in part, to minimize the transfer of certain vibrations or other types of motion from a first component or structure in a vehicle (e.g., a wheel or wheel assembly) to a second component or structure in the vehicle (e.g., a vehicle body). In a passive suspension system, various components of the suspension system may serve to passively damp motion. For example, in a passive suspension system, a damper (e.g., a hydraulic damper) may be used to reduce vehicle body motion and/or vertical wheel motion such as wheel-hop. Typically, a passive hydraulic damper includes a fluid filled cylinder into which a piston, connected to a piston rod, is inserted. In an active suspension system, an actuator, driven by a power source, may be utilized to actively apply an intervening force between the vehicle body and a wheel or wheel assembly in order to actively counteract undesirable physical movement in one or both. In both passive and active suspension systems, a top mount is generally utilized to physically couple a piston rod (e.g., the piston rod of a passive damper or the piston rod of an actuator) to the vehicle body.

Generally, the damper of a passive suspension system generates a force, referred to as a “damping force,” in a direction opposing or resisting the direction of motion of the first structure (e.g., wheel assembly) and/or second structure (e.g., vehicle body of the vehicle). For example, if the wheel assembly of a vehicle is set in motion in an upward direction (due to, for example, travelling over a bump in the road), the damper of a passive system may generate a force in the downward direction that opposes the motion (opposite the direction of motion), but may not generate force in the upward direction (in the direction of motion). Likewise, a damper of a semi-active suspension system may also generate a force effectively opposing the direction of motion of the first structure. Semi-active suspension systems differ from passive suspension systems in that semi-active suspension systems may achieve some control over a magnitude of the damping force (e.g., a magnitude of the force opposing the direction of motion).

An actuator of an active suspension system may be capable of generating forces either opposing or resisting the motion (a damping force) and in the direction of motion (referred to as an active force) thus assisting the motion. For example, if the wheel assembly of a vehicle is set in motion in an upward direction, the actuator of an active suspension system may be controlled to either actively assist the upwards motion of the wheel assembly by generating an active force in the upward direction (in the direction of motion), or to oppose upwards motion of the wheel assembly by generating a damping force in the downward direction (opposite the direction of motion and thus opposing it).

Active suspension systems may include actuators (e.g., electro-hydraulic actuators, electro-mechanical actuators (e.g. ball screw linear actuators), and electrical actuators (e.g. linear electric motor)) interposed between a wheel assembly and a vehicle body to apply forces on the vehicle body and the wheel assembly over a broad spectrum of frequencies in order to control the motion of the vehicle body and/or the wheel assembly.

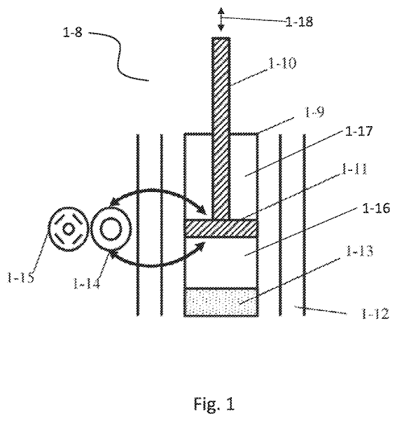

Various components of an exemplary active suspension system, including one or more electro-hydraulic actuators, are described in detail in U.S. patent application Ser. No. 14/602463, filed Jan. 22, 2015 and herein incorporated by reference in its entirety. Particular reference is made to FIG. 1-13 and FIG. 1-15, as well as the accompanying description in paragraphs 938-958, which disclose various embodiments of an electro-hydraulic actuator and associated components for use in an active suspension system.

As used herein, the term hydraulic motor-pump refers to a hydraulic pump or a hydraulic motor. A hydraulic motor-pump may refer to a single apparatus capable of operating alternatively as a hydraulic pump or a hydraulic motor, as such apparatuses are known in the art. As used herein, the term electric motor-generator refers to an electric motor or an electric generator. An electric-motor generator may refer to a single apparatus capable of operating alternatively as an electric motor or an electric generator, as such apparatuses are known in the art.

An embodiment of an electro-hydraulic actuator that may be integrated into an active suspension system is illustrated in FIG. 1. According to the embodiment illustrated in FIG. 1, the actuator 1-8 includes a hydraulic motor-pump 1-14 operatively coupled to an electric motor-generator 1-15 and in fluid communication with a compression chamber 1-16 and a rebound chamber 1-17 of a cylinder 1-9. The compression chamber 1-16 and rebound chamber 1-17 may be separated by a piston 1-11 attached to a piston rod 1-10. Controlling electric power that is supplied to the electric motor-generator 1-15 may drive the hydraulic motor-pump 1-14 and may result in elevation of fluid pressure in one of the chambers (e.g., the compression chamber 1-16) relative to the other chamber (e.g., the rebound chamber 1-17), thereby applying a controlled net active force on the piston 1-11 in the direction of motion of the piston. The electro-hydraulic actuator 1-8 may also operate in passive mode, to apply a damping force opposite the direction of motion.

In certain embodiments, the electric motor-generator 1-15 is bidirectional. In certain embodiments the bidirectional electric motor-generator is an electric motor (e.g., a brushless direct current (BLDC) motor). In certain embodiments, a motor controller is electrically connected to said electric motor-generator. As would be recognized by one of ordinary skill in the art, a motor controller may include one or more microprocessors, associated software code, and/or electronic circuitry, to vary operation (e.g., torque, angular speed) of the electric motor-generator as a function of one or more input signals. In certain embodiments, the motor controller may operate by varying an amount of electrical power provided to the electric motor-generator based on the one or more input signals, thereby varying an amount of active and or passive force applied to the piston as a function of the one or more input signals. In certain embodiments, the input signals may include any combination or permutation of: an operating state of the vehicle and/or a component of the vehicle, a measure of energy available to the vehicle, a measure of instantaneous or time-averaged power consumption of one or more components of the vehicle, road conditions or type, steering input (e.g., position of a steering wheel), forward or reverse vehicle speed, forward or reverse vehicle acceleration, vertical speed and/or acceleration of one or more structural components (e.g., vehicle body, wheel, wheel assembly), pedal positions (e.g., accelerator, brake), road conditions, ambient temperature, information contained in a data base, information provided by or collected about one or more vehicle occupants, weather conditions, and/or manually specified occupant preferences. Examples of operating states of a vehicle may include, without limitation, for example, autonomous (“auto-pilot”) mode, semi-autonomous mode, non-autonomous (e.g., driver controlled) mode, fuel-saving mode, energy-saving mode, etc. Occupant preferences may establish vehicle state. For example, a vehicle occupant may specify a “sporty mode” as an operational mode for the vehicle, in which case the motor controller operates to prioritize ride handling over ride comfort. Alternatively, for example, a vehicle occupant may specify a “comfort mode,” in which case the motor controller operates to prioritize ride comfort over ride handling. As another example, a vehicle occupant may assign a priority to noise suppression, in which case the motor controller operates so that acoustic noise production is minimized. In other cases, for example, in the case of a mechanic performing a diagnostics test, the vehicle occupant may want to disable noise mitigation. In other cases, for example, an occupant may specify a motion-sickness control mode, in which the motor controller operates such that available energy is directed to reduce motion-sickness inducing vibrations while audible noise producing vibrations are not suppressed or suppressed to a lesser degree.

In various embodiments, the motor controller may be, for example, an open loop, a feed forward, a P, an I, a PI, a PD, or a PID controller. In various embodiments, the motor controller may use a feedback, feed forward, open loop, or closed loop control system to control operation of the electric motor-generator. In certain embodiments, the motor controller is a BLDC motor controller. In certain embodiments, a motor controller and an associated electro-hydraulic actuator may be located in close proximity to each wheel of a vehicle.

The inventors have observed that, when used as part of an active suspension system of a vehicle, the operating pressure of the compression chamber and/or rebound chamber of the actuator 1-8 may reach, for example, several hundred pounds per square inch, resulting in a substantial net force on the piston that is conveyed to the piston rod. Particularly, in some applications, the inventors have observed system pressures of approximately 500 psi, resulting in piston rod forces of, for example, 700N-4000N depending on the characteristic dimension (e.g., diameter) of the piston rod. It is noted that the exemplary operating pressures and forces are provided as non-limiting examples and pressures and/or forces greater or smaller than these ranges are contemplated as the disclosure is not so limited.

Hydraulic pumps typically do not output a constant flow of volume, but instead produce pulsations of fluid flow. This phenomenon is known in the art as flow ripple or pressure pulses. In the electro-hydraulic actuator illustrated in FIG.1, the inventors have recognized that flow ripple caused by the hydraulic motor-pump 1-14 may result in oscillations in the amount of net force applied to the piston 1-11 and conveyed to the piston rod 1-10 inducing vibrations in the axial (longitudinal) direction 1-18.

The oscillations in the force applied to the piston (and conveyed to the piston rod) caused by flow ripple are referred to herein as force ripple. Alternatively or additionally, certain forces originating from other sources (e.g., travelling over a pothole or a bump in the road, road surface imperfections, navigating a turn, braking, accelerating) may induce vibrations or other vertical motion in the piston rod. Regardless of the source of said motion, when the piston rod is physically connected to a second structure (e.g., a vehicle body) via a top mount, a portion of said motion and/or force may transfer from the piston rod, through the top mount (not shown in FIG. 1), and into the vehicle body or other connected structure (not shown in in FIG. 1), which may result in undesirable consequences such as, for example, degrading ride comfort and/or producing audible noise.

In view of the above, the inventors have recognized the benefits associated with methods and apparatuses that modify operation of the top mount and/or the piston rod in order to prevent or diminish the transfer of, certain undesirable vibrations and/or forces, at least in certain frequency bands, from the damper or actuator (e.g. the piston rod) to a vehicle body, for example, through the top mount, or other connected structure. Inventors have recognized that a cancellation force may be actively applied to a supported structure (e.g., a top mount) in order to fully or partially mitigate undesirable vibrations or motions, at least in some frequency bands, from being transmitted to the vehicle body.

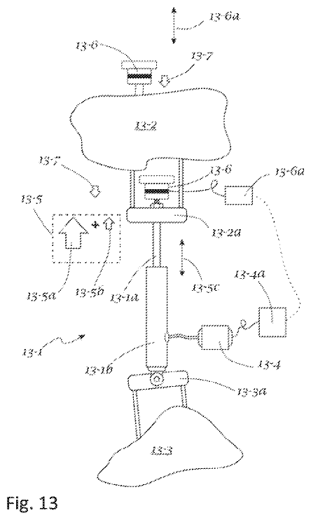

FIG. 13 illustrates an embodiment of an actuator 13-1, (for example, an electro-hydraulic actuator, an electro-mechanical actuator, a linear electric motor) interposed between first structure 13-2 (e.g., vehicle body) and second structure 13-3 (e.g., a wheel assembly). Actuator 13-1 includes a component 13-1a (e.g., an actuator rod) and component 13-16 (e.g. an actuator housing) which may be made to move relative to each other to apply forces on the structures.

Component 13-1a may be connected to structure 13-2 by device 13-2a (for example, a top-mount, a suspension bushing). Component 13-1b may be connected to structure 13-3 by device 13-3a (for example, a suspension bushing, a top-mount).

In certain embodiments, a power pack 13-4 (e.g., a motor-pump, a power supply) works cooperatively with actuator 13-1 to produce a primary force 13-5, acting in direction 13-5c) which may be applied to device 13-2a and may include a desired force component 13-5a and a parasitic force component 13-5b. The power pack 13-4 is operatively coupled to controller 13-4a by a link (e.g., hardwire link, wireless link).The parasitic force 13-5b may be due to imperfections and/or limitations of, for example, of the actuator 13-1, the power pack 13-4, the interface 13-4b and/or controller 13-4a.

The presence of the parasitic force component 13-5b (for example, ripple force produced by a hydraulic motor pump) may have an undesirable effect on the structure 13-2 (for example, the parasitic force made increase the noise level in a vehicle body under certain operating condition). A second actuator 13-6 may be used to apply a properly timed reaction force 13-7, for example, on component 13-1a, device 13-2a, and/or the structure 13-2. The reaction force may partially or fully cancel the effect of the parasitic force 13-5b on, for example, one or more of structure 13-2, device 13-2a, and component 13-1a. The reaction force may act along direction 13-6a, but may at least include a component that is in the direction 13-5c.

Controller 13-6a is operatively coupled to actuator 13-6 in order to produce a properly timed reaction force 13-7. Controller 13-6a may control actuator 13-6 based on information received from controller 13-4a, one or more sensors, and/or from a database. This information may include, for example, the magnitude, frequency, phase of parasitic force 13-5b, the state of the power-pack 13-4 (e.g. the angular position of a rotor of a pump, or rotor of a motor-pump relative to a stator), an acceleration of component 13-1a, the acceleration of component 13-1b, the strain in component 13-1a, a strain in device 13-2a.

In certain embodiments, at least partially based on this information, controller 13-6a causes actuator 13-6 to produce a reaction force that at least partially cancels the effect of the parasitic force 13-5b on structure 13-2 and/or device 13-2a. It is noted that, in certain embodiments, controllers 13-4a and 13-6a may be co-located and/or combined into a single controller. It is also noted that power-pack 13-4 may be remote from actuator 13-1, co-located with it, or physically attached to it for form an integral unit.

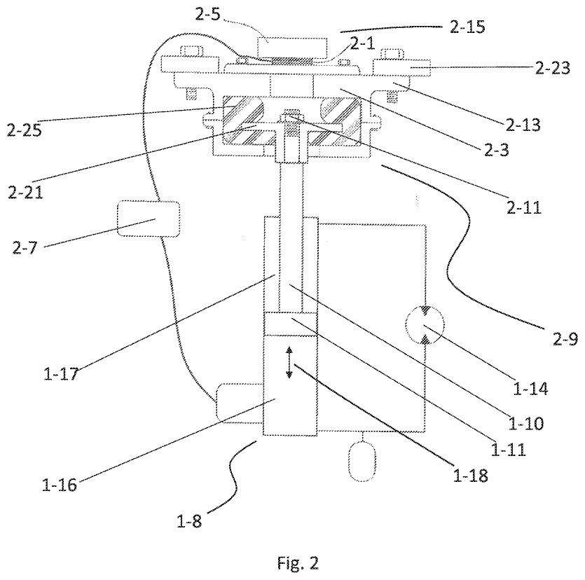

FIG. 2 illustrates a top mount with a vibration mitigation actuator according to one embodiment of the disclosure. As illustrated, in certain embodiments, the vibration canceling top mount system includes an active vibration mitigation device 2-15 that includes (i) a reaction actuator 2-1 mounted to a top mount bracket 2-3, (ii) a reaction mass 2-5 that is physically attached to the reaction actuator 2-1, and (iii) a reaction actuator controller 2-7 that is electrically connected to the reaction actuator 2-1. In certain embodiments, the reaction actuator 2-1 may be a piezoelectric actuator. In certain embodiments, the reaction actuator 2-1 is a piezoelectric stack. In certain embodiments, the reaction actuator 2-1 is a linear actuator.

In the above embodiment, the reaction mass 2-5 may be any body of mass, such as, for example, a plate, disc, a cuboid, a cylinder, a regular or irregular polyhedron, etc. The reaction mass may include any material, such as, for example, a liquid, a solid, metal (e.g., lead, iron) or metal alloy, plastic, ceramic, or any composite combination of materials.

In certain embodiments, the reaction actuator 2-1 is configured to mount onto a top mount 2-9 via attachment to a top mount bracket 2-3 such that the reaction actuator 2-1 is interposed between the reaction mass 2-5 and at least a portion of the top mount bracket 2-3. The top mount 2-9 may be attached to or attachable to a piston rod 1-10. For example, in certain embodiments, the top mount includes a strike plate 2-21, disposed within the top mount 2-9, which may include one or more openings therethrough into which a first end of the piston rod 1-10 may be attached. This attachment may be accomplished by, for example, inserting the first end of the piston rod, which may be threaded, through one of the openings and using one or more nuts 2-11 or other fasteners to secure the piston rod 1-10 to the strike plate 2-21. In certain embodiments, the top mount bracket 2-3 may include a flange 2-13 for attaching the top mount 2-9 to the vehicle body 2-23. In certain embodiments, the flange 2-13 includes one or more openings therethrough for securing the top mount to a vehicle body using, for example, bolts, threaded studs, or other fasteners. In certain embodiments, an elastomeric material or other compliant material (e.g., a rubber, a synthetic polymer) 2-25 occupies at least a portion of an intermediate volume interposed between the strike plate and at least a portion of the top mount bracket 2-3.

Without wishing to be bound to any particular theory, the reaction actuator 2-1 may be controlled to expand or contract in the axial/longitudinal direction 1-18 or effectively in the axial direction such that the reaction mass 2-5 is accelerated in a first direction, thereby resulting in equal and opposite forces exerted on the top mount 2-9 and the reaction mass 2-5. Precise control of expansion/contraction of the reaction actuator 2-1 may be exploited to actively induce forces into the top mount with a controlled frequency and magnitude. These induced forces may be used to effectively counteract or cancel (e.g., partially or fully) certain vibrations (e.g., vibrations due to wheel events, road events, flow ripple) conveyed to the top mount 2-9 by the piston rod 1-10. A force actively applied to the top mount 2-9 by the reaction actuator 2-1 to partially or fully counteract or cancel certain vibrations is referred to herein as a “cancellation force.”

Control over expansion/contraction of the reaction actuator 2-1 may be achieved by the reaction actuator controller 2-7. In certain embodiments, the reaction actuator controller 2-7 includes one or more microprocessors, software code, and the associated electronic circuitry to produce and apply a modulable signal (e.g., electrical signal such as, for example, an applied voltage) to the reaction actuator 2-1. In various embodiments, the reaction actuator controller 2-7 may be, for example, an open loop, a feed forward, a P, an I, a PI, a PD, or a PID controller. In various embodiments, the reaction actuator controller may use a feedback, feed forward, open loop, or closed loop control system to control the operation (e.g., contraction or expansion) of the reaction actuator. In various embodiments, the reaction actuator controller 2-7 may be co-located with the electro-hydraulic actuator controller or combined with it (not shown in FIG. 2).

Without wishing to be bound to any particular theory, variations in the voltage applied across a piezoelectric actuator 2-1 may produce variation of, for example, a length or a thickness of the piezoelectric actuator, thereby causing the piezoelectric actuator to move the reaction mass 2-5 in a manner prescribed by the controller, which may, for example, include alternating contraction and expansion (for example, with respect to its un-energized state) in at least one direction. During expansion or contraction of the piezoelectric actuator in an axial direction 1-18, the reaction mass 2-5 may be accelerated upwards and/or downwards, and a corresponding equal and opposite cancelling or compensating forces may be exerted on the top mount 2-9 and the reaction mass 2-5. Modulation of a voltage signal across the piezoelectric actuator actively applies forces to the top mount 2-9. These actively induced forces, whose frequency and magnitude is controlled by the reaction actuator controller 2-7, may be used to substantially counteract undesirable vibrations (e.g., vibrations due to wheel events, road events, flow ripple) conveyed to the top mount 2-9 by the piston rod 1-10.

In certain embodiments, the piston rod 1-10 and piston 1-11 of FIG. 2 are part of an electro-hydraulic actuator 1-8, an embodiment of which is described above and illustrated in FIG. 1. In embodiments where the electro-hydraulic actuator 1-8 may be driven by a rotary action hydraulic motor-pump, which may be a positive displacement pump (e.g., a gerotor, an external gear pump, a vane pump, etc.), a flow ripple generated by the hydraulic motor-pump can be related to an angular position of one or more rotating elements (e.g., rotor, inner or outer gerotor) of the hydraulic motor-pump. As one of the rotating elements (e.g., rotor, gear) of the hydraulic motor-pump is coupled to a rotor of an electric motor-generator driving the hydraulic motor-pump, the position of the rotor of the electric motor-generator and rotating element of the hydraulic motor-pump are correlated with one another. Accordingly, a flow ripple may further be correlated with a position of the rotor of the electric motor-generator and/or any additional rotating components coupled to the rotor where the position can be detected or determined by a sensor. In order to counteract force ripple (induced vibrations) conveyed to the piston rod 1-10 due to flow ripple of the hydraulic motor-pump, the reaction actuator controller 2-7 may modulate the applied signal (e.g., the magnitude and/or direction of applied voltage) based, in part, on one or more of: (i) an angular position of a rotating element of the hydraulic motor-pump, and (ii) an angular position of the rotor of the electric motor-generator. Alternatively or additionally, vibrations or vertical motion due to force ripple or other sources conveyed to the piston rod 1-10 may be monitored, measured and or predicted by sensing one or more of: (i) an instantaneous force and/or pressure applied to the piston, (ii) a vertical acceleration of the piston 1-11, (iii) a vertical acceleration of the piston rod 1-10, (iv) a vertical acceleration of one or more suspension components physically coupled to the electro-hydraulic actuator (e.g., wheel, wheel assembly), (v) a pressure difference between the compression chamber 1-16 and the rebound chamber 1-17, and (vi) a torque applied to the rotary hydraulic motor-pump 1-14.

In light of the above, in certain embodiments the reaction actuator controller 2-7 is electrically connected to, for example, a set of one or more sensors (e.g., hall-effect sensors, encoders, pressure transducers, accelerometers, flowmeters, strain gauges) that respond to (e.g., generate an electrical signal corresponding to) one or more of: a position of a rotating element of the hydraulic motor-pump of the electro-hydraulic actuator, a position of the rotor of the electric motor-generator of the electro-hydraulic actuator (e.g., an angular position of the rotor in relation to a reference point on a stator), an amount of net force applied to the piston, a pressure differential between the rebound chamber and the compression chamber of the electro-hydraulic actuator, an absolute or gauge pressure of the rebound chamber and/or compression chamber, an acceleration of one or more suspension system components (e.g., a damper piston, a damper piston rod, a wheel and/or wheel assembly), and a flow rate to or from the hydraulic motor-pump of the electro-hydraulic actuator. In certain embodiments, the reaction actuator controller applies an electric signal (e.g., a voltage) across the reaction actuator, and one or more values corresponding to characteristics of the electrical signal (e.g., a magnitude and/or a direction of the applied voltage) are varied based on a set of one or more inputs corresponding to: the sensed position of the rotating element(s) of the hydraulic motor-pump, the sensed position of the rotor, the sensed amount of force applied to the piston, the sensed acceleration of the one or more suspension system components, the sensed pressure differential between the rebound chamber and compression chamber, the sensed pressure of the rebound chamber and/or compression chamber, and the sensed flow rate across the hydraulic motor-pump.

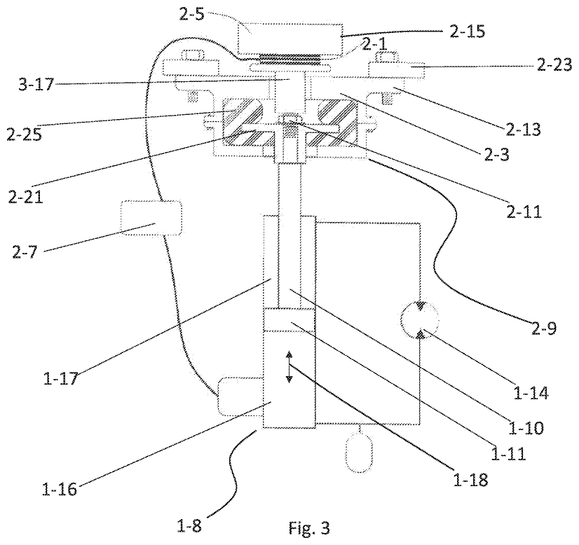

In certain embodiments, a cancellation force applied directly to the piston rod may more effectively mitigate transfer of certain vibrations to the top mount and/or vehicle body. FIG. 3 illustrates another embodiment in which an active vibration mitigation device 2-15 further includes a mounting member 3-17 attached to the reaction actuator 2-1 for joining the reaction actuator to a piston rod 1-10. In certain embodiments, the mounting member 3-17 includes one or more openings into which one end of a rod (e.g., a piston rod) 1-10 can be inserted. In certain embodiments, the one or more openings and at least a portion of the piston rod 1-10 may be threaded, allowing the mounting member 3-17 to fasten directly to the piston rod 1-10 without the need for additional attachment devices. In certain embodiments, the mounting member includes an opening therethrough, into which a portion of the piston rod may be inserted and secured to the mounting member using a nut or other fastener. In the illustrated embodiment, therefore, the vibration mitigation device 2-15 is fixedly attached to the piston rod instead of to a top mount bracket of a top mount.

In certain embodiments, the reaction actuator controller may be configured to predict or approximate instantaneous pressure ripple and/or force ripple at a given time based on a set of one or more inputs. Alternatively or additionally, such information may be made available to the controller. In certain embodiments, the reaction actuator controller may utilize a feed forward model to predict or approximate force ripple and/or pressure ripple using the set of inputs, as discussed in detail below. A model is understood to mean a set of one or more algorithms, functions, rules, and/or logic steps that generate an output parameter or parameters based, in part, on one or more input parameters. In certain embodiments, as described below, the feed forward model may access one or more ‘maps’ that relate one or more system parameters (e.g., flow ripple, pressure ripple, force ripple, reaction acceleration of a reaction mass, etc.) to a set of one or more input variables.

In certain embodiments, a pressure ripple map may be obtained for a given hydraulic motor-pump that, for example, relates pressure ripple (e.g., magnitude and/or phase) at one or more operating conditions as a function of a position parameter. In certain embodiments, the position parameter locates: (i) an angular position of a rotating element of the hydraulic motor-pump (e.g., an angular position of a gear of the hydraulic motor-pump, an angular position of a shaft of the hydraulic motor-pump), and/or (ii) an angular position of a rotor of an electric motor-generator operatively coupled to the hydraulic motor-pump.

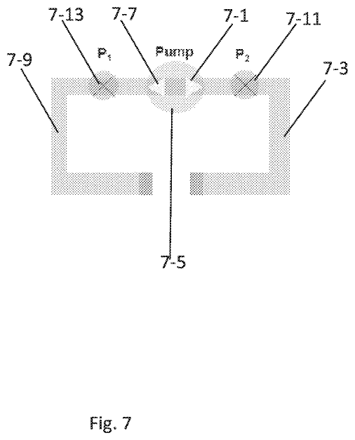

FIG. 7 illustrates an embodiment of an external test or laboratory system that may be used for generating a pressure ripple map. In certain embodiments, a first port 7-1 of the hydraulic motor-pump 7-5 is in fluid communication with a first chamber 7-3 and a second port 7-7 of the hydraulic motor-pump is in fluid communication with a second chamber 7-9. In certain embodiments, the first chamber and second chamber may be arranged such that the only fluid path between the first chamber and second chamber is through the hydraulic motor-pump 7-5. In certain embodiments, a first pressure sensor 7-11 detects a first pressure of the first chamber and a second pressure sensor 7-13 detects a second pressure of the second chamber. In certain embodiments, a position sensor (not pictured, e.g., a hall-effect sensor and optical encoder) is integrated into the hydraulic motor-pump and/or an electric motor-generator operatively coupled to the hydraulic motor-pump and detects the angular position of: (i) one or more rotating elements of the hydraulic motor-pump (e.g., a shaft, an inner gear) or (ii) a position of a rotor of the electric motor-generator. In certain embodiments, the first chamber may be in fluid communication with an accumulator (not shown). In certain embodiments, the accumulator includes an accumulator piston exposed to fluid in the first chamber on a first side and a pressurized gas on a second side opposite the first side of the accumulator piston. As shown in FIG. 7, the hydraulic motor-pump may be considered to have an infinite impedance at both the inlet and outlet ends, i.e. that the only flow path present in the apparatus of FIG. 7 is that of hydraulic leakage past the hydraulic motor-pump. In certain embodiments, a variable flow restrictor (e.g., a needle valve) (not shown) may be placed between the first fluid chamber and the second fluid chamber. In certain embodiments, the hydraulic motor-pump is operatively coupled to an electric motor-generator (e.g., an DC motor) (not shown) that is in communication with a motor controller that controls, for example, an operating torque and/or speed of the electric motor-generator. The first and second pressure sensors may be, for example, commercially available pressure sensors such as an Omega PX409. The electric motor-generator may be, for example, a brushless DC motor.

In order to generate a pressure ripple map, in certain embodiments, with the hydraulic motor-pump turned off, the first chamber and second chamber may biased to an elevated pressure. In certain embodiments, the elevated pressure may fall in a range having a lower value and an upper value. The lower value may be 50 psig, 100 psig, 150 psig, 200 psig, 250 psig, 300 psig, 350 psig, 400 psig, 450 psig, 500 psig, 550 psig, 600 psig, 650 psig, or 700 psig, and the upper value may be 5000 psig, 1000 psig, 950 psig, 900 psig, 850 psig, 800 psig, 750 psig, 700 psig, 650 psig, 600 psig, 550 psig, or 500 psig. In certain embodiments, pressurization may be achieved by using a second pump (not shown), wherein a discharge port of the second pump is in fluid communication, via one or more valves, with the first chamber and/or second chamber. In certain embodiments, following pressurization, the one or more valves may be closed such that there is no open flow path between the first chamber and the second pump and likewise no open flow path between the second chamber and the second pump. Pressurizing the first chamber and second chamber prior to obtaining a pressure ripple map and/or leakage map may, for example, avoid cavitation on the suction side of the hydraulic motor-pump during operation, even at high pump speeds. Further, pressurizing the first chamber and second chamber may provide more accurate ripple data for hydraulic motor-pumps expected to be used in elevated pressure applications.

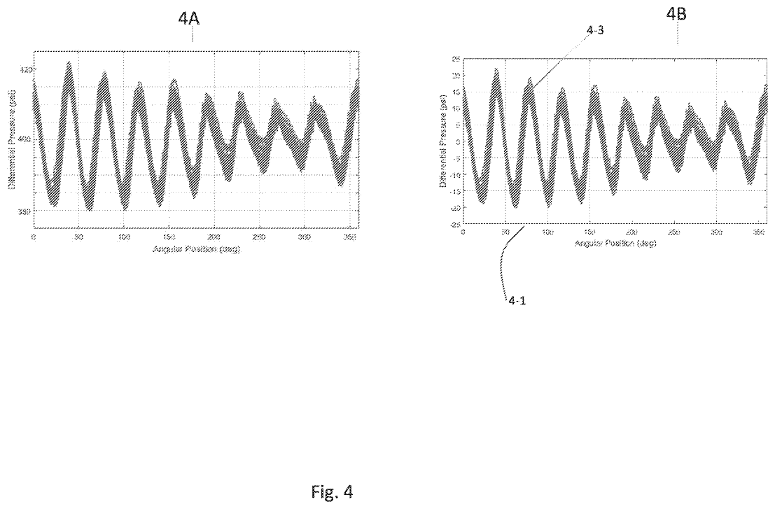

In certain embodiments, a motor controller (not shown in FIG. 7) applies a signal to an electric motor-generator operatively coupled to the hydraulic motor-pump such that a time-constant torque is applied to the hydraulic motor-pump 7-5 by the electric motor-generator. In certain embodiments, a pressure differential map is generated by recording the observed pressure differential and a position parameter while maintaining a constant torque applied to the hydraulic motor-pump. An example of one embodiment of a pressure differential map is shown in FIG. 4A. In the embodiment shown in FIG. 4A, a constant applied torque of 40 Nm results in a nominal (or mean) pressure differential of approximately 400 psi, with instantaneous pressure differentials varying from approximately 380 psi to approximately 420 psi as a function of angular position of a rotor of the electric motor-generator operatively coupled to the hydraulic motor-pump.

A pressure ripple map may be derived from a pressure differential map (such as that shown in FIG. 4A) by subtracting a nominal pressure differential from each recorded pressure differential value. An example of a pressure ripple map is shown in FIG. 4B. FIG. 4B illustrates the pressure ripple map obtained by subtracting the nominal differential pressure (400 psi) from each pressure differential value of the pressure differential map in FIG. 4A. In certain embodiments, the stored values in a pressure ripple map may include, for example, values normalized by a maximum value and/or actual values for pressure ripple.

If the hydraulic motor-pump is to be used as part of an electro-hydraulic actuator (such as illustrated in FIG. 1), in certain embodiments the pressure ripple map may be used to predict and/or calculate, by for example a CFD model, the pressures in the compression chamber 1-16 and the rebound chamber 1-17. These pressures may be used to compute a force ripple map by using the equations Fc=Pc*A and Fr=Pr*A′, where Fc represents force applied to the compression side of the piston, Pc represents the pressure in the compression chamber, and A represents a cross-sectional area of a piston and Fr represents force applied to the rebound side of the piston, Pr represents the pressure in the rebound chamber, and A′ represents an annular cross-sectional area of a piston exposed to Pr.

Pressure ripple for any given operating condition, such as illustrated in FIG. 4B, FIG. 4B may be mapped into a net force ripple:

F_{ripple/compression}=Fc−Fcₐᵥₑ

F_{ripple/rebound}=Fr−Frₐᵥₑ

FNetᵣᵢₚₚₗₑ=F_{ripple/compression}−F_{ripple/rebound}

A reaction actuator, such as for example, the actuator shown in FIG. 2 or FIG. 3, may be used to at least partially cancel or compensate for the effect of FNetᵣᵢₚₚₗₑ on the top mount.

In certain embodiments, therefore, a net force ripple map may be generated that defines: a net ripple force applied to a hydraulic actuator piston, piston rod, and/or top-mount as a function of a position parameter. In certain embodiments, the position parameter locates: (i) an angular position of a rotating element of the hydraulic motor-pump (e.g., an angular position of a gear of the hydraulic motor-pump, an angular position of a shaft of the hydraulic motor-pump), and/or (ii) an angular position of a rotor of an electric motor-generator operatively coupled to the hydraulic motor-pump. As used herein, the term “ripple map” may refer to a pressure ripple map and/or a net force ripple map.

In certain embodiments, rather than utilizing an external test system (such as that shown in FIG. 7) to generate a ripple map, one or more maps may be generated using an “in-situ” calibration or “self-learning” method (e.g., while the hydraulic motor-pump is integrated into an electro-hydraulic actuator). Returning to FIG. 2, in certain embodiments the reaction actuator controller 2-7 may be configured to selectably operate in active mode, wherein the reaction actuator controller applies a signal (e.g., an electrical signal) to the piezoelectric actuator 2-1. Alternatively the reaction actuator controller 2-7 may operate in self-learning mode, wherein the reaction actuator controller uses the piezoelectric actuator as a sensor, rather than an actuator, and receives one or more signals (e.g., a voltage) from the piezoelectric actuator as it is stressed by the action (e.g. acceleration) of, for example, the top mount or the piston rod. The piezoelectric actuator may be used as a sensor to generate a voltage signal that is proportional to the transient forces that may be applied to it by the reaction mass and the top-mount (in the embodiment in FIG. 2) or the piston rod (in the embodiment in FIG. 3).

For example, in certain embodiments, when operating in a self-learning mode, the reaction actuator controller may be configured to receive as inputs (a) a position parameter from the hydraulic motor-pump and/or electric motor-generator, and (b) a voltage parameter from the piezoelectric actuator. In certain embodiments, the position parameter locates: (i) an angular position of a rotating element of the hydraulic motor-pump (e.g., an angular position of a gear of the hydraulic motor-pump, an angular position of a shaft of the hydraulic motor-pump), and/or (ii) an angular position of a rotor of an electric motor-generator operatively coupled to the hydraulic motor-pump. Returning now to FIG. 2, a force (e.g., caused by force ripple) exerted into the top mount 2-9 by the piston rod 1-10 may transfer into the piezoelectric actuator 2-1 and/or reaction mass 2-5. In response to the transferred force, the piezoelectric actuator 2-1 may experience a temporary state of either compressive and/or tensile stress, depending on the direction of the transferred force, and may generate a voltage (referred to herein as a reaction voltage) proportional to the transferred force. It is noted that in some embodiments the piezoelectric actuator may be biased with a compressive force so that it does not undergo tensile stress during operation.

In self-learning mode, in certain embodiments the reaction actuator controller 2-7 may be configured to monitor and/or record the generated reaction voltage and the position parameter simultaneously. Thus, in certain embodiments, a reaction voltage map may be generated that characterizes voltage generated across the piezoelectric actuator as a function of the position parameter (e.g., reaction voltage) for a given operating condition (e.g. motor torque, motor speed). Alternatively, in certain embodiments the recorded voltage may be used, using techniques known in the art, to determine force exerted on the actuator. In this way, measuring the reaction voltage may be used to generate a force ripple map for the given operating condition.

In certain embodiments, the observed reaction voltages may be converted, using techniques known in the art, into values corresponding to acceleration of the reaction mass 2-5. Acceleration of the reaction mass resulting from force ripple may be referred to herein as reaction acceleration. Alternatively or additionally, in certain embodiments, an accelerometer in communication with the reaction actuator controller 2-7 may be attached to the reaction mass 2-5, in which case the reaction acceleration of the reaction mass 2-5 may be recorded based on a signal reported by the accelerometer. Regardless of whether reaction acceleration of the reaction mass may be determined based on observed reaction voltage across the piezoelectric actuator, or via a separate accelerometer, a reaction acceleration map for the given operating condition may be generated that characterizes reaction acceleration of the reaction mass as a function of the position parameter for a given operating condition.

As used herein, the term “reaction map” is used to refer to a map that relates any reaction parameter (e.g., a parameter that describes a reaction of one or more components to a force ripple) (e.g., a reaction voltage generated by the piezoelectric actuator in response to force ripple, a reaction acceleration of the reaction mass in response to force ripple, etc.) as a function of one or more operating parameters such as, for example, a position parameter locating: (i) an angular position of a rotating element of a hydraulic motor-pump and/or (ii) an angular position of a rotor of an electric motor-generator operatively coupled to the hydraulic motor-pump. The term ripple map, as used herein, is understood to encompass reaction maps.

In certain embodiments, in a self-learning mode the reaction actuator controller 2-7 may receive and record one or more additional inputs such as, for example, an operating torque of the electric motor-generator and/or hydraulic motor-pump, a pressure of the compression chamber, a pressure of the extension chamber, an acceleration of a suspension component, an operating speed and direction of the electric motor-generator and/or hydraulic motor-pump, an operating state of the vehicle, an temperature of hydraulic fluid, user input parameters, the position of the piston 1-11 in the electro-hydraulic actuator 1-8, or any combination or permutation thereof. In certain embodiments, the reaction actuator controller may be configured to generate a plurality of ripple maps (e.g., reaction acceleration maps, reaction voltage maps, ripple maps), each map corresponding to a different operating condition of, for example, the hydraulic motor-pump, electric motor-generator, vehicle, and/or actuator (e.g., different nominal pressure differential, nominal applied force, nominal operating torque, temperature, operating mode, etc.).

In certain embodiments, one or more ripple maps may be determined computationally based on geometrical configurations or details of one or more elements of the hydraulic motor-pump, empirically by using one or more sensors, or a combination of these and various other computational/modeling and/or empirical methods known in the art.

While several specific types of maps (e.g., pressure ripple maps, force ripple maps, reaction acceleration maps, reaction voltage maps, etc.) have been described above, there are a variety of other maps which may be envisioned, and the disclosure is not so limited as to the specific disclosed examples. Modifying the disclosed methods and systems to generate and utilize other types of maps is considered within the capabilities of one of ordinary skill in the art in view of the teachings and examples herein.

Having discussed various examples of techniques which may be used to generate a variety of maps (e.g., ripple maps and/or reaction maps), embodiments of an open-loop control system utilizing a feed forward model are now described in which a reaction actuator controller 2-7 utilizes the one or more maps to determine a cancellation signal, such that applying the cancellation signal to the reaction actuator, for example a piezoelectric actuator 2-1, at least partially counteracts the effect of hydraulic ripple (e.g., flow ripple, pressure ripple, and/or force ripple), generated by a hydraulic motor-pump, on, for example, the top mount.

Returning to FIG. 2, a ripple in force applied to the piston may be conveyed to the piston rod and to the top mount due to operation of the hydraulic motor-pump. Without wishing to be being bound by theory, in order to mitigate transfer of ripple forces from the piston to the top mount, the active vibration mitigation device 2-15 may apply a counteracting force of similar magnitude but in an opposite direction. If FNetᵣᵢₚₚₗₑ may be the instantaneous ripple force applied to the piston at a given time, then to at least partially counteract FNetᵣᵢₚₚₗₑ at the top-mount, the active-vibration mitigation device 2-15 may apply a cancellation force, F_{cancel}, that is approximately equal to:

F_{cancel}=−(FNetᵣᵢₚₚₗₑ)

As is known in the art, in some embodiments, the force generated by a piezoelectric actuator may be directly related to a voltage applied to the piezoelectric by a controller. For the active vibration mitigation device 2-15, applying a positive voltage to the piezoelectric actuator 2-1 may cause the piezoelectric actuator to expand in an axial direction 1-18, thereby exerting, for example, an upward force on the reaction mass 2-5 and a downward force on the top mount 2-9. The reaction mass 2-5 may accelerate per the equation F=ma, where F may be a force exerted on the reaction mass 2-5 as a result of expansion of the piezoelectric actuator 2-1, m may be a mass of the reaction mass 2-5, and a may be a resulting acceleration of the reaction mass 2-5. For example, a reaction mass 2-5 with a mass of 1 kg, experiencing upward force of 130 N may be expected to result in an acceleration of approximately 130 m/s².

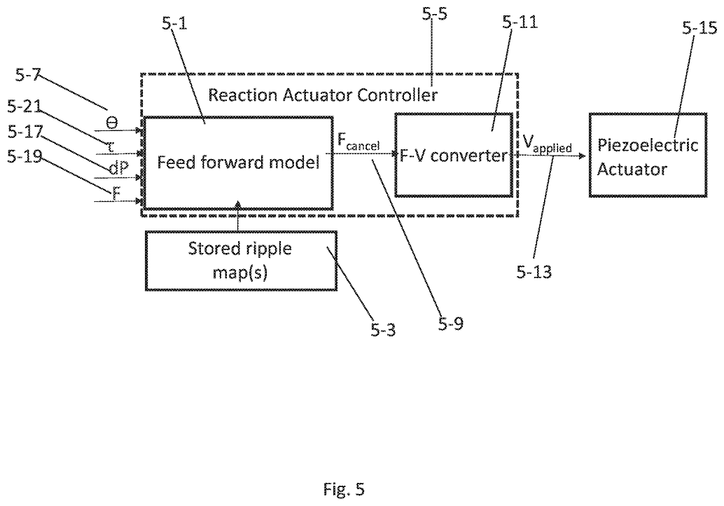

As illustrated in FIG. 5, in some embodiments, a feed forward model 5-1 may be utilized based on the algorithms discussed above. In certain embodiments, a ripple map may be stored (e.g., as a lookup table) in non-volatile computer memory accessible to the reaction actuator controller 5-5. In certain embodiments, the reaction actuator controller may receive an angular position parameter (θ) 5-7 that corresponds to an angular position of a rotating element of the hydraulic motor-pump and/or an angular position of a rotor of an electric motor-generator coupled to (e.g., driving) the hydraulic motor-pump. The feed forward model may be used to determine a cancellation force value, F_{cancel} 5-9. In some embodiments, the cancellation force value derived by the feed forward model may then be supplied using models known in the art. In certain embodiments, the force-voltage converter module 5-11 may be software code that, when executed by the reaction actuator controller, causes the reaction actuator controller to determine a voltage signal based on the input cancellation force using techniques known in the art.

In certain embodiments, a plurality of ripple maps may be stored, each ripple map corresponding to, for example, a different operating condition of the hydraulic motor-pump and/or actuator (e.g., a different nominal pressure differential, nominal applied force, nominal operating torque, temperature, etc.). In certain embodiments, during operation of the hydraulic motor-pump, the reaction actuator controller may receive as an input the operating pressure differential dP 5-17, applied force F 5-19, operating torque 5-21, temperature, and/or other operating state, and may select an appropriate ripple map that most closely or appropriately corresponds to the given input. In certain embodiments, one or more input values may be based on values determined by interpolating and/or extrapolating from known values in the ripple map. In certain embodiments, a first set of one or more ripple maps may be stored, each ripple map of the first set corresponding to hydraulic motor-pump rotation in a first direction; and a second set of one or more ripple maps may be stored, each ripple map of the second set corresponding to hydraulic motor-pump rotation in a second direction. In this case, the reaction actuator controller may receive as an input the direction of hydraulic motor-pump rotation, and may select an appropriate ripple map based on the direction of the hydraulic motor-pump rotation.

In certain embodiments, a map (e.g., a ripple map or a reaction map) may be generated and/or stored as one or more tables (e.g., a look-up table), arrays (e.g., a one dimensional array or a multi-dimensional array), plots, or functions. In certain embodiments, the stored ripple maps and/or feed-forward model may be updatable or adaptable. For example, in certain embodiments, one or more inputs from one or a plurality of secondary sensors may be used as feedback to the ripple model in order to update model parameters or maps. For example, based on the one or more inputs, the reaction actuator controller may determine that the reaction actuator is applying a cancellation force inadequate to fully mitigate transfer of a ripple force into the vehicle body at a given condition. The motor controller may update the model parameters or the maps used in the model, such that the next time the given condition is encountered, the motor controller applies an updated cancellation force adequate to more fully mitigate transfer of the ripple force into the vehicle body. In this manner, the model may dynamically update its parameters to account for additional factors as they relate to ripple and the corresponding cancellation signal.

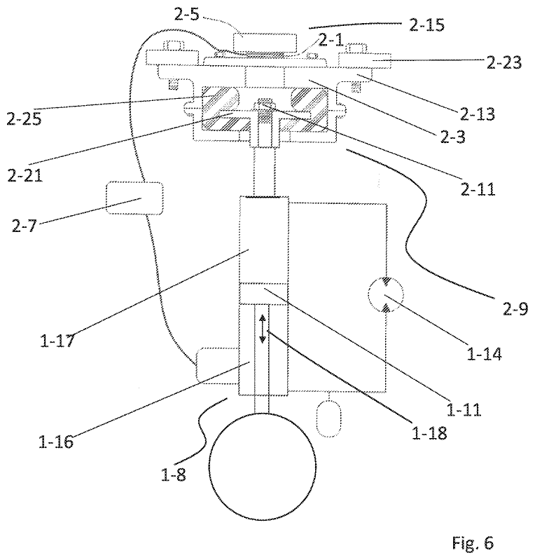

In certain embodiments, a suspension system damper or actuator assembly may be mounted in a vehicle with the rod facing up in a vertical or near vertical direction. For the sake of clarity, in the embodiments described above, reference is made only to “top” mounts. However, it should be understood that the current disclosure may be applied to any appropriate compliant attachment in any physical orientation. For example, in some embodiments, the actuator or damper may be oriented such that the piston rod may be maintained in a horizontal or near horizontal direction, or in an inverted direction (e.g., with the piston rod facing down). In an embodiment of an inverted orientation, the top mount may physically attach the housing of the damper/actuator cylinder as illustrated in FIG. 6. In certain embodiments, a solenoid linear actuator may be utilized in place of, or in addition to, the piezoelectric actuator. In these embodiments, the reaction actuator controller applies a modulable electrical current to the solenoid actuator. In certain embodiments, the reaction actuator controller applies a current to the solenoid actuator, and the magnitude of the current may be varied based on one or more input parameters corresponding to, for example: the rotor position, the amount of force applied to the hydraulic piston, the acceleration of the one or more suspension components, the pressure differential between the rebound chamber and compression chamber, the pressure of the rebound chamber and/or compression chamber, and the flow rate across the hydraulic motor-pump.

While given components of the system have been described separately, one of ordinary skill will appreciate that some of the functions may be combined or shared in given hardware, instructions, program sequences, code portions, and the like. For example, in certain embodiments, the reaction actuator controller may be integrated into the motor controller of an active suspension system. In certain embodiments, at least one or more common hardware components and/or functions may be shared between the motor controller described above and the reaction actuator controller. For example, the reaction actuator controller and motor controller may utilize a single microprocessor, may share a plurality of microprocessors, and/or may access shared memory.

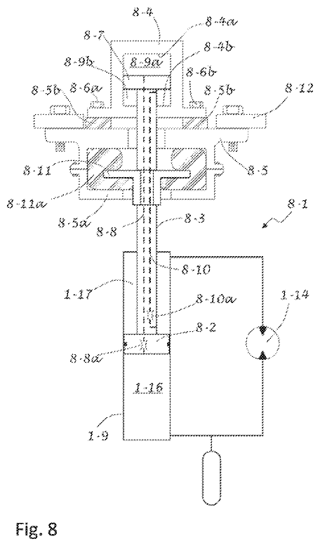

Other classes of apparatuses and methods may be used to counteract or cancel (e.g., partially or fully) certain forces applied at the interface between two structures. An embodiment of an electro-hydraulic actuator that may be integrated into an active suspension system is illustrated in FIG. 8. In this embodiment, a cancelling or compensating force may be applied to the piston rod. According to this embodiment, an electro-hydraulic actuator includes a hydraulic motor-pump 1-14 which may be operatively coupled to an electric motor-generator (not shown) and in fluid communication with a compression chamber 1-16 and a rebound chamber 1-17 that are contained in cylinder (or housing) 1-9. The compression and rebound chambers may be separated by a piston 8-2. Piston rod 8-3 is attached to piston 8-2 at a first end and to piston 8-7 at a second end. Piston 8-7 is slidably received in a second housing 8-4 which is attached to top-mount 8-5 by one or more attachment devices such as, for example, bolts 8-6a and 8-6b. In certain embodiments, second housing 8-4 may be separated from top-mount 8-5 by an intervening compliant body 8-5b (e.g. washers, a slab), which may include an elastomeric material or other material that may exhibit certain spring constant and/or damping coefficient.

Piston 8-7 divides the volume in the second housing 8-4 into a first volume 8-9a that is in fluid communication with the compression volume 1-16 through flow channel 8-8 and a second volume 8-9b that is in fluid communication with the extension volume 1-17 through flow channel 8-10. In certain embodiments, flow channels 8-8 and 8-10 are at least partially or wholly contained in piston rod 8-3.

In certain embodiments, piston rod 8-3 may include a radially outwardly extending flange 8-3a that may be attached (e.g. glued, welded, soldered) to the piston rod 8-3. Strike plate 8-11, which is at least partially enclosed in bracket 8-5a of top mount 8-5, may be held securely in place against an annular surface of flange 8-3a by a fastener 8-3b (e.g. a collar with a set screw).

The top-mount 8-5 includes at least one compliant element 8-11a interposed between the top-mount bracket 8-5a and strike plate 8-11 in order to restrict relative motion between the strike plate 8-11 and the top mount bracket 8-5a. In certain embodiments, the compliant element 8-1 may exhibit characteristics of a spring and/or a damper.

In the embodiment of FIG. 8, at a first range of pressure fluctuation frequencies (e.g. 0-15 Hz, 0-7 Hz, 0-5 Hz), fluid may be exchanged freely between compression volume 1-16 and first volume 8-9a and between extension volume 1-17 and second volume 8-9b such that the pressure differential across piston 8-7, within a certain frequency range, is effectively equal to the pressure differential across piston 8-2. However, at other frequencies (e.g. greater than: 15 Hz, 30 Hz, 100 Hz) communication between chambers 8-9a and 1-16 and chambers 8-9b and 1-17 may be reduced, or effectively eliminated, relative to flow at lower frequencies by selecting appropriate restrictions 8-8a and/or 8-10a and/or the shape, length and cross sections of flow channels 8-8 and/or 8-10. In certain embodiments, by reducing flow at such higher frequencies, the vehicle body may be better isolated from higher frequency disturbances.

For example, in certain embodiments, for pressure fluctuations in the frequency range of 0-15 Hz, the hydraulic forces on piston 8-7 will be effectively balanced by forces on piston 8-2. However, a force in this frequency range may be transmitted to the vehicle body 8-12 because of the pressure differential in chambers 8-9a and 8-9b. The pressure in chamber 8-9a will induce a force in the upward direction on the second housing 8-4 which is a function of the pressure and the area 8-4a. The pressure in chamber 8-9b will induce a force in the downward direction on the second housing 8-4 which is a function of the pressure in that chamber and the annular area 8-4b.

In certain embodiments, for pressure fluctuations at higher frequencies such as higher than 30 Hz, the hydraulic forces on pistons 8-7 and 8-2 will not be in balance. The forces transmitted to the vehicle body in this range will depend at least partially on the mass of the two piston/piston rod assembly and the spring constants and damping characteristics of elements 8-11a and 8-5b.

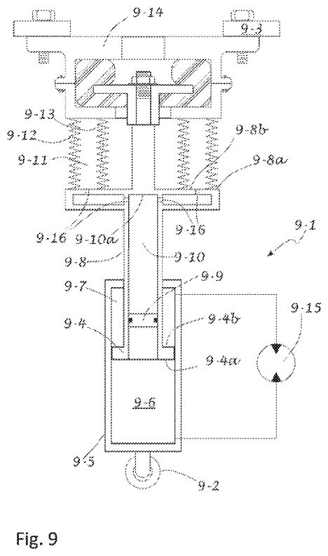

A further embodiment of an electrohydraulic actuator that may be integrated into an active suspension system is illustrated in FIG. 9. In this embodiment a cancelling or compensating force may be applied to the top-mount to at least partially balance the forces applied by a linear actuator.

FIG. 9 illustrates an embodiment of an electrohydraulic actuator 9-1 interposed between wheel assembly 9-2 and a vehicle body 9-3.

Annular piston 9-4 is slidably received in cylinder 9-5 and divides the cylinder into a compression volume 9-6 and an extension volume 9-7. Annular piston 9-4 is physically attached to a piston rod 9-8 that is hollow for at least a portion of its length. The hollow portion of piston rod 9-8 slidably receives floating piston 9-9. In certain embodiments, volume 9-10 functions as the accumulator of the active suspension system.

The floating position 9-9 separates the hydraulic fluid in the compression chamber 9-6 from a gas-filled accumulator 9-10. The gas in accumulator 9-10 is in fluid communication with annular volume 9-11 that is bounded by corrugated cylinder 9-12 and corrugated cylinder 9-13 that has a smaller diameter. The corrugated cylinders 9-12 and 9-13 are sealably attached to the bottom of top-mount 9-14 and to the annular shoulder 9-8a that protrudes radially from piston rod 9-8.

During at least one mode of operation, hydraulic motor-pump 9-15 may be used to induce a pressure differential between the compression volume 9-6 and the extension volume 9-7. The pressure in volume 9-6 (P1) acts on the annular area 9-4a (A1) while the pressure in volume 9-7 (P2) acts on annular area 9-4b (A2). The pressure of the gas in the accumulator volume is effectively equal to the pressure of the hydraulic liquid in the compression volume. As a result of the openings 9-16, pressure of the gas in chamber 9-11 is also equal to the pressure of the gas in the accumulator 9-10. The pressure in volume 9-11 therefore acts on both area 9-10a (A3) and on the annular area 9-8b (A4) that is formed by the intersection of cylinders 9-12 and 9-13 and the annular surface of shoulder 9-8a.

As a result, in certain embodiments, the net force acting on the piston 9-4 and piston rod 9-8 due to fluid (hydraulic and gas) may be equal to:

Fnet=P1×A1−P2×A2+P1×A3−P1×A4

In such an embodiment, if:

A4=A1+A3−A2

### Then:

Fnet=(P1−P2)*A2

where the net force on the top mount is independent of the accumulator pressure that is established when it is charged or as a result of ambient temperature changes. Therefore, in certain embodiments, as a result of the cancellation or compensating force applied on A3, the system may be more insensitive to accumulator pressure. As a result, in some embodiments it may be possible to use softer rubber or other soft elastomeric top mount materials since they will not have to support large static or low frequency forces.

In another aspect, methods and systems for improving motion control units including integrated multiple actuators are described. Suspension systems including integrated multiple actuators are described in US provisional application 62/387,410, filed Dec. 24, 2015; US provisional application 62/330,619, filed May 2, 2016; and PCT application PCT/US2016/068558, filed Dec. 23, 2016. The contents of each aforementioned patent application is hereby incorporated by reference in their entirety.

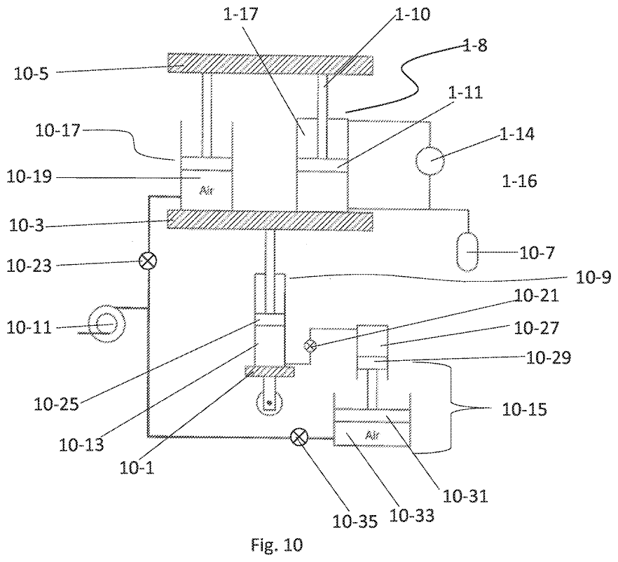

Integration of multiple actuators in a suspension system may allow increased control over ride parameters. Accordingly, FIG. 10 illustrates an embodiment of a motion control unit including multiple actuators. In certain embodiments, the motion control unit includes a spring/actuator perch 10-3 interposed between a wheel assembly 10-1 and a vehicle body 10-5. In certain embodiments, an air spring 10-17 oriented in mechanical parallel to an electro-hydraulic actuator 1-8 may be interposed between the spring/actuator perch 10-3 and vehicle body 10-5. In certain embodiments, a coil spring (not shown) may be used in place of, or in addition to, the air spring 10-17. In certain embodiments, the electro-hydraulic actuator 1-8 may be capable of actively changing a vertical position (e.g., raising and/or lowering) of the vehicle body 10-5 relative to the spring/actuator perch 10-3. In certain embodiments, an air pump or air compressor 10-11 may be in fluid communication with a first chamber 10-19 of the air spring 10-17. In certain embodiments, the compression chamber may be in fluid communication with an accumulator 10-7, which may include a diaphragm and/or floating piston (not shown) interposed between hydraulic fluid and a gas chamber comprising pressurized gas (e.g., nitrogen). In certain embodiments, a first valve 10-23 may be located along, and capable of controlling flow in, the flow path between the air compressor 10-11 and the first chamber 10-19. As used herein, the term spring/actuator perch is understood to mean a perch (e.g., a spring perch, damper perch) that movably supports a spring, for example the air spring 10-17, and an actuator, for example an electro-hydraulic actuator 1-8.

As illustrated, in certain embodiments, the motion control unit may include a perch actuator 10-9 that physically couples the spring/actuator perch 10-3 to the wheel assembly 10-1. In certain embodiments, the perch actuator 10-9 may be capable of changing a vertical position (e.g., raising and/or lowering) of the spring/actuator perch 10-3 with respect to the wheel assembly 10-1. In certain embodiments, the perch actuator includes a second piston 10-25 exposed on one side to a fluid filled second chamber 10-13.

In certain embodiments, a fluid filled external chamber 10-27 may be in fluid communication with the second chamber 10-13. A third piston 10-29 may be slidably inserted into the external chamber 10-27. In certain embodiments, the third piston 10-29 may be rigidly attached to a fourth piston 10-31. The fourth piston may be exposed to an air chamber 10-33 on one side that may be in fluid communication with an air pump or air compressor 10-11. The third piston 10-29 and fourth piston 10-31 may form part of a pressure intensifier 10-15 (also known in the art as a pressure booster). In certain embodiments, a second valve 10-21 (e.g., an on-off valve or a variable valve) may be placed in a fluid path between the external chamber 10-27 and the second chamber 10-13 of the perch actuator 10-9. Additionally or alternatively, in certain embodiments, a third valve 10-35 may be placed in a fluid path between the air compressor 10-11 and air chamber 10-33. Alternatively or additionally, in certain embodiments fluid may be allowed to drain from the air chamber 10-33 by means of an alternative flow path (not shown).

During operation, the perch actuator 10-9 may be used to control the relative motion between the spring/actuator perch 10-3 and the wheel assembly 10-1. For example, in order to raise the spring/actuator perch 10-3 relative to the wheel assembly 10-1, in certain embodiments, with the second valve 10-21 open and the third valve 10-35 open, the air compressor 10-11 may turn on and pump high pressure air to the air chamber 10-33, resulting in upward movement of the fourth piston 10-31 and the third piston 10-29. Upward movement of the third piston 10-29 may displace fluid (e.g. hydraulic fluid) in the external chamber 10-27, causing fluid to flow from the external chamber 10-27 to the second chamber 10-13, thereby resulting in upward movement of the second piston 10-25 and extension of the perch actuator 10-9. In certain embodiments, the second valve 10-21 and/or third valve 10-35 may then be closed to lock the perch actuator 10-9 in place, thereby maintaining a vertical position of the spring/actuator perch 10-3 relative to the wheel assembly 10-1 even when, for example, the air pump 10-11 may be turned off.

The electro-hydraulic actuator 1-8 may be used as described elsewhere in the disclosure to apply a controlled active force to the vehicle body 10-5 in order to, for example, raise or lower the vehicle body 10-5 relative to the spring/actuator perch 10-3. In certain embodiments, the air compressor 10-11 may be used to deliver high pressure air to the first chamber 10-19 of the air spring 10-17 with the first valve 10-23 open, followed by closing of the first valve 10-23 to lock the vertical position of the vehicle body 10-5 relative to the spring/actuator perch 10-3 in place even when, for example, the air pump 10-11 may be turned off. In the embodiment shown in FIG. 10, the electro-hydraulic actuator 1-8 and the air spring 10-17 may be used synergistically to control movement of the vehicle body 10-5 relative to the spring/actuator perch 10-3. For example, the air spring 10-17 and the electro-hydraulic actuator 1-8 may be sized such that they may be operated together to raise the vehicle.

In certain embodiments, the electro-hydraulic actuator 1-8 and the perch actuator 10-9 may be configured to operate in different frequency ranges. These frequency ranges may either be separate from one another, or they may include overlapping frequency ranges, as the disclosure is not so limited.

As can be seen, an actuation system integrating an active spring/actuator perch, such as that shown in FIG. 10, allows enhanced control of the suspension system and vehicle body by permitting active movement of the spring/actuator perch relative to the wheel assembly, as well as independent control of movement of the vehicle body relative to the spring/actuator perch.

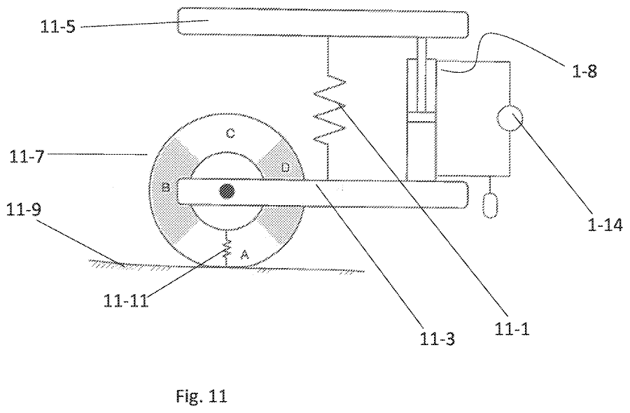

In yet another aspect, a system and method for assessing the integrity and state of one or more of a vehicle's tires is disclosed. FIG. 11 illustrates an embodiment of a suspension system including an electro-hydraulic actuator 1-8 interposed between a wheel assembly 11-3 and a vehicle body 11-5. In certain embodiments, a linear electric motor actuator, an electro-mechanical actuator (e.g., ball screw actuator), or other linear actuator may be used in place of the electro-hydraulic actuator 1-8. In certain embodiments, the suspension system includes a spring 11-1 (e.g., an air spring, a coil spring) oriented in mechanical parallel or effectively parallel to the electro-hydraulic actuator 1-8. In certain embodiments, a pneumatic tire 11-7 may be rotatably attached to the wheel assembly 11-3. In certain embodiments, a set of sensors includes one or more acceleration sensors, position sensors, velocity sensors, or any combination or permutation thereof that are located one or more locations on the tire, one or more locations on the wheel assembly and/or any component that effectively approximates the movement of the wheel assembly for example in the vertical direction.

As is known in the art, a pneumatic tire in contact with the ground 11-9 effectively acts as a pneumatic spring 11-11. Without wishing to be bound to any particular theory, the tire and wheel assembly complex constitutes a spring-mass system. Consistent with its use in the art, the term “unsprung mass” is used herein to describe the mass of the tire, wheel assembly (including, for example, wheel hubs, wheel bearings, wheel axles, brakes, etc.), and other associated components or masses that effectively move in a direction (e.g. the vertical direction) with the wheel assembly.

In certain embodiments, the hydraulic actuator 1-8 may exert a force in a pre-selected direction (e.q. the vertical direction) on the wheel assembly 11-3, thereby causing displacement (e.g., compression or extension) of the pneumatic spring 11-11. In certain embodiments resonance of the unsprung mass may be induced, by the actuator, at a natural (or resonant) frequency of the spring-mass system of the unsprung mass, wherein, in some embodiments, the resonant frequency may be proportional to the square root of the ratio of the spring constant of the tire to the mass of the unpsrung mass. In certain embodiments, the set of sensors may be used to detect one or more velocity values, position values, and/or acceleration values of the tire and/or wheel assembly in the vertical direction, and the spring constant of the pneumatic spring 11-11 may be determined based on the detected velocity values, position values, acceleration values and/or resonant frequency of the unsprung mass system.

In view of the above, in certain embodiments, the electro-hydraulic actuator 1-8 may be operated to induce vibrations in the wheel assembly 11-3 and tire 11-7 system at a range of frequencies. A frequency-dependent response of the wheel assembly 11-3 and/or tire 11-7 to the induced vibrations may then be observed using the set of sensors. Without wishing to be bound to any particular theory, in certain embodiments, the maximum displacement of the pneumatic spring 11-11 may occur at the resonant frequency of the tire-wheel assembly complex. By observing the reaction velocity, acceleration, and/or position of the tire and/or wheel assembly in response to the induced vibrations of varying frequencies, it may be possible to deduce the resonant frequency of the spring-mass system formed by the tire-wheel assembly complex and therefore to determine the spring constant of the tire using, for example, the relation f=sqrt(k/m), where f is the determined resonant frequency, k is the spring constant of the tire, and m is the known mass of the unsprung mass.

In certain embodiments, as described above, a natural frequency for the tire-wheel assembly (or tire-unsprung mass) system may be determined by operating the electro-hydraulic actuator 1-8 to exert a time-varying force on the wheel assembly 10-1 and tire 10-3, and observing the response of the wheel assembly 10-1 and tire 10-3. In certain embodiments, based on the determined natural frequency, a value for the spring constant of the tire may be determined. Alternatively or additionally, the spring constant of the tire maybe be determined directly by measuring the magnitude of the deflection of the wheel assembly 11-3 with respect to the ground 11-9 when acted upon by a predetermine force applied by an actuator. In certain embodiments, the value for the spring constant of the tire may be used to determine an air pressure within the tire, since the value of the spring constant of the tire may be a, at least partly, a function of the air pressure in the tire. In certain embodiments, upon determining that the determined air pressure may be above a first threshold value or below a second threshold value, a notification (e.g., a visual notification such as, for example, a warning light; an audible notification such as, for example, an audible alarm; an electronic flag, a text message to a pre-selected phone number, an email to a predetermined address) may activate to alert an operator of the vehicle of an overinflated or underinflated tire, respectively.

In certain embodiments, the damping coefficient of the actuator may be actively or passively reduced or minimized in order to accentuate the resonance peak of the wheel motion induced by the actuator more easily detectable with the sensor set. Accentuating the peak may make the resonance frequency more readily detectable and the pressure reading more accurate.

In certain embodiments, the resonance for determination of tire inflation may be induced only when the vehicle is at rest and/or when the vehicle is travelling below a pre-set speed.

In certain embodiments, the tire 11-7 may be divided into a plurality of sectors (A, B, C, and D in FIG. 11). In certain embodiments, the tire may be divided into 2, 3, 4, 5, 6, 8, 10, or more sectors. Ideally, the spring constant of the tire should remain approximately constant regardless of which specific section of the tire may be in contact with the ground 11-9 at any given time. If different values for spring constants may be observed based on which specific section is in contact with the ground 11-9, this may indicate that the tire may be defective or compromised (e.g., that at least a portion of the tire may be experiencing dry rot, cracking, etc). In certain embodiments, one or more position sensors may be integrated into the tire and/or the wheel assembly in order to detect an angular position of the tire and/or determine which sector is in contact with the ground at any given time. In certain embodiments, a plurality of spring constants may be determined for the tire, each corresponding to a different angular position of the tire. In certain embodiments, upon determination that one or more spring constants differ from another one of the spring constants by a third threshold, a notification (e.g., a visual notification such as, for example, a warning light; an audible notification such as, for example, an audible alarm, an electronic flag, a text message to a pre-selected phone number, an email to a predetermined address) may activate to alert an operator of the vehicle that there may be a problem with the integrity of the tire.

U.S. Pat. No. 4,547,267 discloses a method of determining tire inflation pressure based the natural frequency of the tire. This approach however relies on sensors that work in conjunction a passive a passive suspension system. As a result measurements an only be made when the vehicle is moving which makes it difficult to separate changes in the natural frequency of the tire from other effects. The methods and apparatus disclosed herein take advantage of an active suspension system and can induce vibrations in a wheel at any appropriate speed. U.S. Pat. No. 4,547,267 is incorporated herein in its entirety. Particular reference is made to FIG. 3 and the description contained in Column 2 line 42 to Column 4 line 45.

In yet another aspect, methods and systems are described for varying the angle of azimuth of the cylinder 1-9 of an electro-hydraulic actuator 1-8. The inventors have recognized that integration of an electro-hydraulic actuator 1-8 into a vehicle's suspension system may be impeded due to a lack of available space in a vicinity each tire of the vehicle. Allowing for dynamic control over an orientation of the electro-hydraulic actuator may allow for more facile integration of the actuator into limited volumes of space.

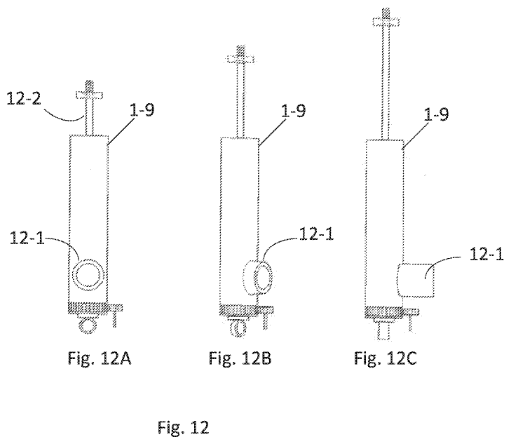

As shown in FIG. 12, in certain embodiments the piston may be slidably and rotatably inserted into the cylinder 1-9 of an electro-hydraulic actuator. As illustrated in FIG. 12A, in certain embodiments, the cylinder 1-9 may be located at a first angle of azimuth when the piston may be located at a first vertical position. In certain embodiments, a change in the vertical position of the piston induces a change in the angle of azimuth of the cylinder 1-9 such that, as illustrated in FIG. 12B, the cylinder 1-9 may be located at a second angle of azimuth when the piston may be located at a second vertical position. In certain embodiments, further change in the vertical position of the piston results in a further change in the angle of azimuth of the cylinder 1-9 such that, as illustrated in FIG. 12C, the cylinder 1-9 may be located at a third angle of azimuth when the piston may be located at a third vertical position. In certain embodiments, rotation about the vertical axis may be accomplished by use of a motor.

In some embodiments, the azimuth angle of the damper body may be altered by a connection with one or more vehicle suspension components. For example, this azimuth angle may be altered by movement of the vehicle steering rack, or another suspension component that changes position when one or more of the wheels is steered. In other embodiments, the connection may be made through a linkage, Bowden cable, or gears.

In certain embodiments, the exterior of the cylinder 1-9 may have one or more grooves, indentations, or teeth that may physically couple to, for example, a spur gear such that rotation of the spur gear causes the cylinder 1-9 to rotate such that the azimuthal position of one or more protrusions 12-lattached to cylinder 1-9 changes in a manner that may be proportional to the position of the piston rod 12-2.

As the term is used herein, the term “physically attached to” may encompass, for example, two components which are fastened, attached, bonded, glued, joined, latched, or otherwise secured to each other where the joint formed by attaching two or more components may be capable of transmitting at least an appropriate force under at least certain operating conditions. The term “physically attached” may encompass, for example, any of a permanent attachment (e.g., welded to), a semi-permanent attachment (e.g., via use of a removable fastener such as a nut), a removable attachment(e.g., via use of a latch), a movable attachment (e.g., the first component may be independently moved in at least one direction relative to the second component), a rotatable attachment (e.g., the first component may be rotated relative to the second component), a fixed attachment (e.g., the position of the first component may be effectively fixed relative to the second component), and/or a compliant attachment (e.g., the first component may be attached to the second component via an intermediate compliant element such as, for example, a spring). As a further example, a first component may be physically attached to a second component via one or more intermediate components. For example, in the case of a first component that may be physically attached to a second component that may be physically attached to a third component, it is understood that the first component may be said to be “physically attached to” the third component.

As the term is used herein, a first component is said to be “in communication” with a second component when the first component is capable of sending and/or receiving electrical power and/or one or more signs, signals, messages, images, sounds, or information of any nature to and/or from a second component. The term “in communication” may encompass, for example, one way communication (e.g., in which a first component is capable of sending information to a second component but not capable of receiving information from the second component) or two way communication (e.g., in which a first component is capable of both sending information to and receiving information from a second component). Components may communicate via, for example, wires or cables (e.g., cables carrying electrical signals, cables carrying optical signals, etc.), may communicate wirelessly (e.g., via transmission of radio waves, microwaves, or other electromagnetic radiation), or may use a combination of wires, cables, and/or wireless communication. As a further example, a first component may be in communication with a second component via one or more intermediate components. For example, in the case of a first component that is in communication with a second component that is in communication with a third component, it is understood that the first component may be said to be in communication with the third component. As used herein, it is understood that the term fluid may encompass, for example, compressible and incompressible fluids and the term fluid communication may encompass, for example, hydraulic and pneumatic communication.

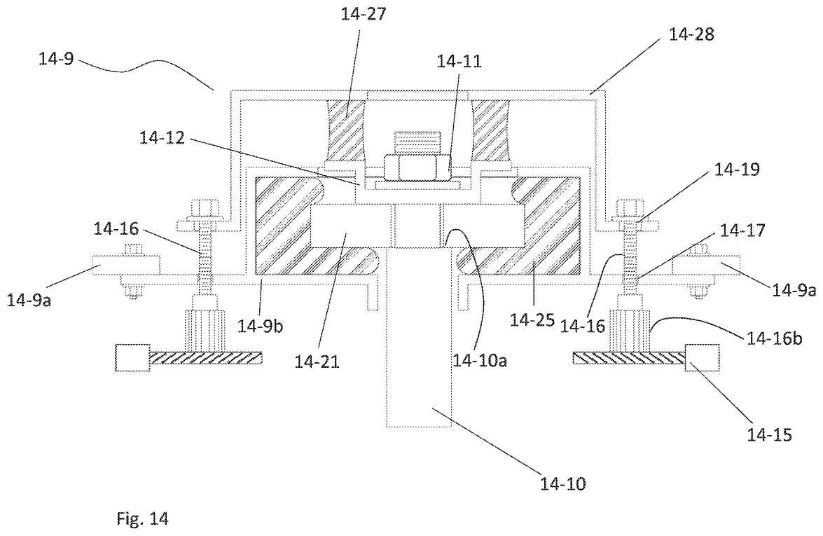

FIG. 14 illustrates an embodiment of a suspension system top mount assembly and piston rod of an actuator (actuator not shown). In FIG. 14, the top mount 14-9 may be interposed between a piston rod 14-10 and a vehicle body 14-9a. In certain embodiments, the top mount 14-9 includes a strike plate 14-21, at least partially enclosed by top-mount bracket 14-9b. The shaft 14-10 may include a distally facing annular shoulder 14-10a. The strike plate 14-21 may include a central opening to receive a threaded first end of the piston rod 14-10. The strike plate may be attached to the piston rod piston rod 14-10 by, for example, an attachment device 14-11, for example a nut, that securely holds the strike plate against the annular shoulder 14-10a. In certain embodiments, a compliant device 14-25 may be constructed, for example, from an elastomeric material, with at least a first spring constant, that restricts the motion of the strike plate relative to the top mount bracket 14-9b.

In certain embodiments, a spring element 14-27 may be used to apply a countervailing force on strike plate 14-21 to at least partially cancel the force applied by piston rod 14-10. In certain embodiments, spring element 14-27 may be constructed from, for example, an elastomeric material, and may be interposed between element 14-28 and element 14-12. The axial length of spring element 14-27, and correspondingly the countervailing force applied on element 14-12, may be determined by adjusting the axial distance between them.

In certain embodiments element 14-12 may be an inverted top hat shaped component that is securely attached to the strike plate while element 14-28 is a top hat shaped component that is adjustably attached to the top mount bracket 14-9b.

One or more threaded bolts 14-16 may be used to adjustably attach elements 14-9b and 14-28. In the embodiment in FIG. 14, the bolts 14-16 pass through the through-holes 14-19 and engage bracket 14-9 by means of threaded holes 14-17. Bolts 14-16 also penetrate beyond the holes 14-17 and engage toothed wheels 14-16b which are driven by worm gears 14-15.

The force applied on the strike plate by piston rod 14-10 may include a constant or slowly changing component (e.g. slower frequency) and a more rapidly changing (e.g., higher frequency) component. Depending on the operating and/or environmental conditions of the suspension (e.g., temperature), the force applied on the piston rod 14-10 may include a bias force due to the gas pre-charge in the system accumulator (not shown). In certain embodiments, it may be desirable to compress or stretch spring element 14-27 to at least partially balance the slowly and/or rapidly changing components of the force applied by the piston 14-10 on the strike plate 14-21. Worm gears 14-15 may be powered by various power sources (e.g., and electric motor, a hydraulic motor) in response to measurements of one or more sensors (e.g., thermocouples, strain gauges, pressure sensors) that are used to monitor one or more operating and/or environmental parameters. In some embodiments, the mounting bracket 14-19 could be a material/component that changes length with temperature so that the slowly changing component of the force that results from change in temperature of the actuator is compensated through a change in compression or extension of elastomeric component 14-27.

What is claimed is:

1. A method of mitigating an effect of a first force applied to a first component, the method comprising:
characterizing an aspect of the first force, wherein the first force is applied by a first actuator to a first component;
determining a second force determined based at least in part on the aspect of the first force;
applying the second force by a reaction actuator thereby at least partially mitigating the effect of the first force on the first component.

2. The method of claim 1, wherein:
the first component is one of a vehicle body and a top mount physically attached to the vehicle body;
the first force is applied to the first component by an actuator component of the first actuator.

3. The method of claim 2 further comprising:
determining a reaction signal, such that transmission of the reaction signal to the reaction actuator causes the reaction actuator to generate the second force;
transmitting the reaction signal to the reaction actuator, thereby causing the reaction actuator to generate the second force.

4. The method of claim 3, wherein the first actuator is a suspension system actuator that comprises:
a cylinder that includes a compression chamber and an extension or a rebound chamber;
a piston that is physically attached to a piston rod, wherein a first side of the piston is exposed to fluid in the compression chamber and a second side of the piston is exposed to fluid in the rebound chamber;
a hydraulic pump, wherein the hydraulic pump is in fluid communication with the rebound chamber and the compression chamber.

5. The method of claim 4, wherein characterizing the aspect of the first force comprises:
accessing a ripple map;
receiving a position parameter corresponding to an angular position of a rotating element of the hydraulic pump of the suspension system;
determining one or more values for the aspect of the first force based at least in part on the ripple map and the position parameter.

6. The method claim 5, wherein characterizing the aspect of the first force comprises:
determining one or more values for the aspect of the first force based at least in part on the set of one or more inputs.

7. The method of claim 6, wherein the vehicle body is part of a vehicle having a mass between 1,300 to 2,500.

8. A vibration-mitigating top mount assembly comprising:
an active suspension actuator;
a reaction actuator;
a reaction mass physically attached to a first side of the reaction actuator; and
a reaction actuator controller in electrical communication with the reaction actuator, wherein the reaction actuator controller applies a signal to the actuator based at least in part on at least one of information received about the operation of the active suspension actuator and a force applied on the top mount by the active suspension actuator.

9. The vibration-mitigating top mount assembly of claim 8, further comprising a mounting member physically attached to a second side of the reaction actuator, wherein the mounting member is physically attachable to a piston rod of an actuator.

10. A diagnostic method for evaluating a condition of a first tire of a vehicle comprising an active suspension system configured to actively transmit a vertical force to the first tire, the diagnostic method comprising:
(i) exerting, with an actuator, a vertical force on the first tire;
(ii) modifying a characteristic of the vertical force, thereby effecting a reaction in the first tire;
(iii) detecting, by a set of one or more sensors, a set of one or more reaction values, the set of reaction values comprising at least one of: (a) one or more vertical velocity values of one or more wheel components (e.g., one or more points on the first tire, one or more points on a wheel assembly linking the first tire to a vehicle body), (b) one or more vertical acceleration values of one or more wheel components, (c) one or more vertical position values of one or more wheel components; and
(iv) determining, by a microprocessor in communication with the set of sensors, based at least in part on the set of reaction values, a first tire parameter.

11. The diagnostic method of claim 10, wherein, the first tire parameter is one of a resonance frequency of the first tire and a spring constant of the first tire.

12. An actuator of a suspension system of a vehicle, comprising:
a cylindrical housing having a longitudinal axis;
a piston slidably received in the housing, wherein the housing is rotatable about the longitudinal axis; and
wherein changing a longitudinal position of the piston relative to the housing results in a change in an angular position of the housing relative to the piston.

13. A method of controlling an effect of force on a structure, comprising:
producing a force with a system that includes a first actuator that is operationally connected to a power-pack, wherein the force includes a desired force component and a parasitic force component;
applying the force to at least one of the structure and a device connected to the structure, wherein the parasitic force component has an effect on the structure;
determining a reaction force for mitigating the effect of the parasitic force component on the structure that is based at least partially on information about at least one component of the system;
applying the reaction force to at least one of the structure and the device connected to the structure; and
mitigating the effect of the parasitic force component on the structure.

14. A method for operating an active suspension system supporting a vehicle body, the method comprising:
applying, with a first actuator of the active suspension system, a first force to a structure, wherein application of the first force to the structure generates an effect having a magnitude;
characterizing the magnitude of the effect;
applying, with a second actuator, a second force to the structure, wherein application of the second force to the structure reduces the magnitude of the effect;
wherein the structure is one of: the vehicle body and a top mount physically attached to the vehicle body.
